(19) United States
(12) Patent Application Publication
(10) Pub. No.: US 2026/0340726 A1
(43) Pub. Date: Oct. 29, 2026

(54) PLATFORM AND DATA STRUCTURE FOR COLLATERAL MOBILITY

(71) Applicant: DTCC DIGITAL (US) INC., JERSEY CITY, NJ (US)

(72) Inventors: George Daniel Doney, Riva, MD (US); Joseph Spiro, Matawan, NJ (US)

(73) Assignee: DTCC DIGITAL (US) INC., JERSEY CITY, NJ (US)

(21) Appl. No.: 19/450,269

(22) Filed: Jan. 15, 2026

Related U.S. Application Data
(60) Provisional application No. 63/793,387, filed on Apr. 23, 2025.

(51) Int. Cl. G06Q 40/04; H04L 9/00

(52) U.S. Cl. CPC G06Q 40/055; H04L 9/50; H04L 2209/56

(57) ABSTRACT

A framework for managing data on a decentralized network is disclosed, including an on-chain decentralized asset data management system. The data management system includes a platform and data structure for collateral mobility and management by providing decentralized standards management. The platform of the present invention provides for real-time transactions of tokenized assets and supports liquidity for market participants.

### CROSS REFERENCES TO RELATED APPLICATIONS

This application claims priority to and the benefit of U.S. Application No. 63/793,387, filed on Apr. 23, 2025, which is incorporated herein by reference in its entirety.

### BACKGROUND OF THE INVENTION

### 1. Field of the Invention

The present invention relates to decentralized asset management systems, and more specifically to a data structure for collateral mobility and management.

### 2. Description of the Prior Art

It is generally known in the prior art to provide platforms for decentralized asset management and data transfer, including collateral movement and management.

Prior art patent documents include the following:

U.S. Pat. No. 12,056,690 for Systems and methods for distributed-ledger based collateral movement by inventors Lobban, et al., filed Feb. 25, 2021, and issued Aug. 6, 2024, is directed to systems and methods for distributed ledger-based collateral movement. A method for distributed ledger-based collateral movement may include: (1) receiving, at a first collateral custodian computer system for a collateral custodian and from a client of the first collateral custodian, a collateral asset for a target asset held by a client of a second collateral custodian; and (2) tokenizing the collateral asset and writing a collateral token to a distributed ledger platform. The second collateral custodian receives, from the distributed ledger platform, the collateral token and releases the target asset to the first collateral custodian in response to receiving the collateral token.

US Patent Publication No. 2024/0346492 for Systems and methods for distributed-ledger based collateral movement by inventors Lobban, et al., filed Jun. 26, 2024, and published Oct. 17, 2024, is directed to systems and methods for distributed ledger-based collateral movement. A method for distributed ledger-based collateral movement may include: (1) receiving, at a first collateral custodian computer system for a collateral custodian and from a client of the first collateral custodian, a collateral asset for a target asset held by a client of a second collateral custodian; and (2) tokenizing the collateral asset and writing a collateral token to a distributed ledger platform. The second collateral custodian receives, from the distributed ledger platform, the collateral token and releases the target asset to the first collateral custodian in response to receiving the collateral token.

U.S. Pat. No. 11,522,700 for Systems, methods, and program products for depositing, holding and/or distributing collateral as a token in the form of digital assets on an underlying blockchain by inventors Auerbach, et al., filed Feb. 22, 2019, and issued Dec. 6, 2022, is directed to a method, system, and program product for depositing, holding and/or distributing collateral in the form of a stable value token for a security token, the tokens being on the same underlying blockchain. Furthermore, is directed to methods, systems, and program products for lending digital assets, such as crypto currency and other related products.

US Patent Publication No. 2021/0374854 for System and computer implemented method for facilitating the transaction and settlement of a financial instrument by inventors McCosker, et al., filed May 3, 2021, and published Dec. 2, 2021, is directed to a computer system for facilitating instantaneous settlement of a financial transaction by a central counterparty system. A validation module validates a client order prior to trade. For a buy order, the validation module is configured to: (a) automatically query one or more trusted data repositories for:—retrieving account data for a nominated funds account;—retrieving meta data associated with the client and/or trade, the meta data including at least one of (i) historical client trading data; and (ii) current market data; (b) implement one or more predictive algorithms to determine a likelihood of settlement for the buy order, utilising the retrieved data. Following validation of the order, implementing an order fulfilment module configured to place the order in a queue responsive to determining that the likelihood of settlement meets or exceeds a predefined threshold.

US Patent Publication No. 2019/0005469 for Collateral management with blockchain and smart contracts apparatuses, methods and systems by inventors Dhupkar, et al., filed Sep. 7, 2018, and published Jan. 3, 2019, is directed to a Collateral Management with Blockchain and Smart Contracts Apparatuses, Methods and Systems (“CMBSC”) that transforms borrow transaction request inputs via CMBSC components into borrow transaction init notification, borrow transaction sync notification outputs. A borrow transaction request associated with a borrow transaction is obtained. Transaction attributes associated with the borrow transaction are stored in a database. The transaction process optimizer component is notified regarding the borrow transaction. A blockchain sync notification associated with the borrow transaction is obtained from the transaction process optimizer component. The stored transaction attributes associated with the borrow transaction are filtered. A smart contract associated with the borrow transaction is generated. The generated smart contract is sent to a blockchain node of a blockchain network. A smart contract notification associated with the smart contract is received. A push notification regarding the smart contract notification is provided to a user interface component of a user's client.

US Patent Publication No. 2022/0309479 for Computer system and method for programmatic collateralization services by inventors O'Meara, et al., filed Mar. 26, 2022, and published Sep. 29, 2022, is directed to a computer system processes a digital representation of an illiquid asset, to confirm accuracy of the digital representation and value of the asset, and generates an asset-information table indicating where the various sections of the digital representation are stored. The system also generates an asset-value token, financial-return tokens, and a data structure that includes a self-executing program. The program associates the asset-value token with the financial-return tokens, so that the illiquid asset becomes a collateral for a decentralized loan transaction implemented using blockchain technology. The use of blockchain technology for decentralized loan transactions enables immutable data traceability.

U.S. Pat. No. 11,204,939 for Data manifest as a blockchain service by inventors Patangia, et al., filed Jul. 18, 2018, and issued Dec. 21, 2021, is directed to methods and systems for providing data manifests as a service (DMAAS). A first computing system, may generate a first data manifest comprising a first count parameter and a first hash parameter associated with a first data exchange transaction between the first computing system and a second computing system, store the first data manifest to a blockchain data store and transfer a data payload of the first data exchange transaction. The second computing system may analyze the data payload received via the transport mechanism, generate a second data manifest including a second count parameter and a second hash parameter and store the second data manifest to the blockchain data store. A DMAAS computing system facilitates access to the blockchain data store, identifies transmission errors, and triggers acceptance of data at the second computing system upon a successful data exchange transaction.

U.S. Pat. No. 11,599,555 for Data manifest as a blockchain service by inventors Patangia, et al., filed Oct. 5, 2021, and issued Mar. 7, 2023, is directed to methods and systems for providing data manifests as a service (DMAAS). A first computing system, may generate a first data manifest comprising a first count parameter and a first hash parameter associated with a first data exchange transaction between the first computing system and a second computing system, store the first data manifest to a blockchain data store and transfer a data payload of the first data exchange transaction. The second computing system may analyze the data payload received via the transport mechanism, generate a second data manifest including a second count parameter and a second hash parameter and store the second data manifest to the blockchain data store. A DMAAS computing system facilitates access to the blockchain data store, identifies transmission errors, and triggers acceptance of data at the second computing system upon a successful data exchange transaction.

US Patent Publication No. 2024/0233020 for Digital assets platform by inventors Yip, et al., filed Oct. 23, 2023, and published Apr. 25, 2024, is directed to a digital assets platform (DAP) uses distributed ledger technology and smart contract programming. The DAP can include distributed and decentralized communication network and application systems that collectively provide end-to-end tokenization, management, and lifecycle processing of digital assets. The assets may be digitally native securities (e.g., bonds, equities, funds, etc.) and non-securities (e.g., digital cash, loans, derivatives), tokenization of real-world assets (securities and non-securities), or any other forms of tokenized assets.

US Patent Publication No. 20240233019 for Digital assets platform by inventors Yip, et al., filed Oct. 23, 2023, and published Apr. 25, 2024, is directed to a digital assets platform (DAP) uses distributed ledger technology and smart contract programming. The DAP can include distributed and decentralized communication network and application systems that collectively provide end-to-end tokenization, management, and lifecycle processing of digital assets. The assets may be digitally native securities (e.g., bonds, equities, funds, etc.) and non-securities (e.g., digital cash, loans, derivatives), tokenization of real-world assets (securities and non-securities), or any other forms of tokenized assets.

US Patent Publication No. 2024/0233018 for Digital assets platform by inventors Yip, et al., filed Oct. 23, 2023, and published Apr. 25, 2024, is directed to a digital assets platform (DAP) uses distributed ledger technology and smart contract programming. The DAP can include distributed and decentralized communication network and application systems that collectively provide end-to-end tokenization, management, and lifecycle processing of digital assets. The assets may be digitally native securities (e.g., bonds, equities, funds, etc.) and non-securities (e.g., digital cash, loans, derivatives), tokenization of real-world assets (securities and non-securities), or any other forms of tokenized assets.

US Patent Publication No. 2024/0233017 for Digital assets platform by inventors Yip, et al., filed Oct. 23, 2023, and published Apr. 25, 2024, is directed to a digital assets platform (DAP) uses distributed ledger technology and smart contract programming. The DAP can include distributed and decentralized communication network and application systems that collectively provide end-to-end tokenization, management, and lifecycle processing of digital assets. The assets may be digitally native securities (e.g., bonds, equities, funds, etc.) and non-securities (e.g., digital cash, loans, derivatives), tokenization of real-world assets (securities and non-securities), or any other forms of tokenized assets.

US Patent Publication No. 2024/0296493 for Method for creating commodity assets from unrefined commodity reserves utilizing blockchain and distributed ledger technology by inventors Youb, et al., filed Feb. 5, 2024, and published Sep. 5, 2024, is directed to a token system and method, employing a token representing an interest in a smart contract, comprising: a distributed ledger, storing parameters of a smart contract, the smart contract representing an agreement, secured by a security interest in property, to execute the security interest unless a token is returned within a period; a communication port configured to interface with an automated communication network for communications between a plurality of cryptographic hardware processors; and an automated distributed virtual state machine, hosted by the plurality of cryptographic hardware processors, employing a distributed consensus model for transaction validation, the automated distributed virtual state machine being configured to: communicate distributed consensus messages through the automated communication network; communicate the token; execute the smart contract defined by the parameters, receiving inputs and producing outputs on a blockchain; and communicate an immutable message for exercise of the security interest.

US Patent Publication No. 2025/0131494 for Automated system and method for collateral management by inventors Ouali, et al., filed Oct. 23, 2024, and published Apr. 24, 2025, is directed to EASY Collateral as a specialized solution designed for bank treasurers to seamlessly integrate with the Eurosystem Collateral Management System (ECMS), Central Banks, the European Central Bank (ECB), and Central Counterparties (CCP). This innovative tool offers bank treasurers permanent access to a comprehensive digital dashboard, providing real-time insights into their asset inventory within ECMS and CCP. With a user-friendly interface, users can effortlessly allocate and mobilize/demobilize credit claims and other marketable collateral with a single click. EASY Collateral also ensures compliance with the new Credit Claims Process, covering registration and mobilization, empowering bank treasurers to navigate evolving regulatory requirements confidently. Furthermore, the system mitigates operational risks while enhancing efficiency, enabling real-time decision-making. In the complex world of collateral management, EASY Collateral simplifies processes and empowers bank treasurers within the ECMS and CCP.

### SUMMARY OF THE INVENTION

The present invention relates to decentralized asset management systems, and more specifically to a data structure for collateral mobility and management.

It is an object of this invention to provide a decentralized asset management system including a data structure for decentralized standards management for seamless collateral mobility.

In one embodiment, the present invention includes a system for collateral mobility and management over at least one distributed ledger network, including at least one computer processor, at least one memory storing computer-readable instructions thereon, a layered blockchain, a net asset pool, a tokenization module operable to tokenize at least one collateral asset, and a collateral module, including a provider function, a receiver function, an agent function, and a conversion order function, wherein the provider function is operable to facilitate deposits of the at least one collateral asset into a collateral pool, withdraw the at least one collateral asset from the collateral pool, allocate the at least one collateral asset, and/or substitute the at least one collateral asset, wherein the receiver function is operable to receive the at least one collateral asset, wherein the agent function is operable to manage the at least one collateral asset, wherein the conversion order function is operable to execute a conversion order between a traditional asset and a digital asset, and wherein the collateral module includes at least one collateral agreement automatically generated from at least one rule, wherein the at least one distributed ledger network is operable to connect to at least one second distributed ledger network, wherein a graph structure is operable to connect the at least one distributed ledger network to the at least one second distributed ledger network, and wherein the at least one tokenized collateral asset is operable to be transferred from a party to a second party in real time across the distributed ledger networks.

In another embodiment, the present invention includes a system for collateral mobility and management over at least one distributed ledger network, including at least one computer processor, at least one memory storing computer readable instructions thereon, a net asset pool, a tokenization module operable to tokenize at least one collateral asset, and a collateral module, comprising a provider function, a receiver function, an agent function, and a conversion order function, wherein the conversion order function is operable to execute a conversion order between a traditional asset and a digital asset, wherein the collateral module includes at least one collateral agreement automatically generated from at least one rule, wherein the net asset pool is operable to execute a withdrawal of the at least one tokenized collateral asset based on the collateral agreement, wherein the at least one distributed ledger network is operable to connect to at least one second distributed ledger network, wherein a graph structure is operable to connect the at least one distributed ledger to the at least one second distributed ledger network, and wherein the tokenized collateral asset is operable to be transferred from a party to a second party in real time across the distributed ledger networks.

In yet another embodiment, the present invention includes a system for collateral mobility and management over at least one distributed ledger network, including at least one computer processor, at least one memory storing computer-readable instructions thereon, a layered blockchain, a net asset pool, a tokenization module operable to tokenize at least one collateral asset, and a collateral module, comprising a provider function, a receiver function, an agent function, and a conversion order function, wherein the conversion order function is operable to execute a conversion order between a traditional asset and a digital asset, and wherein the collateral module includes at least one collateral agreement automatically generated from at least one rule, wherein the at least one distributed ledger network is operable to connect to at least one second distributed ledger network, wherein a graph structure is operable to connect the at least one distributed ledger to the at least one second distributed ledger network, wherein the graph structure includes transaction nodes within transfer networks and bridges that connect networks, and wherein the at least one tokenized collateral asset is operable to be transferred from a party to a second party in real time across the distributed ledger networks.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a chart comparing the benefits of digital collateral as utilized in the platform of the present invention compared to traditional financial collateral.

FIG. 2 illustrates the single asset pool of a platform of the present invention.

FIG. 3 illustrates a schematic diagram of a platform of the present invention.

FIG. 4 illustrates a schematic diagram of a securities lending system of the present invention.

FIG. 5 illustrates a schematic diagram of a tri-party collateral securities lending system of the present invention.

FIG. 6 illustrates a schematic diagram of a collateral-specific securities lending system of the present invention.

FIG. 7 illustrates a tokenized French government bond on the platform according to one embodiment of the present invention.

FIG. 8 illustrates the provider collateral functions offered by the platform according to one embodiment of the present invention.

FIG. 9 illustrates the provider collateral functions offered by the platform according to one embodiment of the present invention.

FIG. 10 illustrates the provider collateral functions offered by the platform according to one embodiment of the present invention.

FIG. 11 illustrates a conversion order executed by a platform according to one embodiment of the present invention.

FIG. 12 illustrates a conversion order executed by a platform according to one embodiment of the present invention.

FIG. 13 illustrates a conversion order executed by a platform according to one embodiment of the present invention.

FIG. 14 illustrates a prior art diagram of a central counterparty clearing house (CCP) and crypto exchange margin call according to a legacy prior art system.

FIG. 15 illustrates a diagram of a CCP and crypto exchange margin call performed on the platform according to one embodiment of the present invention.

FIG. 16 illustrates a screenshot showing a conversion of an asset from one party (BNY) to a second party (MarginCore Tokyo).

FIG. 17 illustrates an overview of a margin agreement between a collateral provider (MarginCore Tokyo) and a collateral receiver (CryptoEx).

FIG. 18 illustrates an overview of a margin agreement between a collateral provider (MarginCore Tokyo) and a collateral receiver (CryptoEx).

FIG. 19 illustrates a screenshot of the platform GUI providing for allocation of assets to meet a margin call according to one embodiment of the present invention.

FIG. 20 illustrates a diagram of the parties, actions, and accounts for a third-party segregation of initial margin according to according to a legacy prior art system.

FIG. 21 illustrates a diagram of the parties, actions, and accounts for a third-party segregation of initial margin according to one embodiment of the present invention.

FIG. 22 illustrates a GUI screenshot of agreements for a collateral pool according to one embodiment of the present invention.

FIG. 23 illustrates a list of assets which are available to be allocated from the collateral pool to a receiver of collateral.

FIG. 24 illustrates a GUI screenshot of the net excess value pledged to the receiver, and a total current recall value based on the assets selected for recall.

FIG. 25 illustrates a GUI screenshot of the platform available to the collateral receiver, including an overview tab, assets tab, agreements tab, and activities tab.

FIG. 26 is a GUI screenshot of the platform for a collateral provider.

FIG. 27 illustrates allocation functionality for allocating assets from the provider pool to a receiver.

FIG. 28 illustrates a GUI screenshot of the platform after allocation has occurred.

FIG. 29 illustrates a GUI screenshot of information for a Basic Attention Token (BAT) token.

FIG. 30 illustrates a GUI screenshot of multiple tokens for which the platform retrieves up to date information.

FIG. 31 illustrates an overview of the BENJI-P token.

FIG. 32 illustrates an overview of the BENJI-P token.

FIG. 33 is a diagram of the parties, assets, and transactions involved with transactions during a major credit event, including a counterparty default.

FIG. 34 is a diagram of the parties, assets, and transactions involved with transactions during a major credit event, including a counterparty default.

FIG. 35 illustrates a GUI screenshot of a configuration page by which the platform provides for a collateral receiver to add acceptable assets as collateral.

FIG. 36 illustrates a GUI screenshot showing the ULTRA token being added as acceptable collateral by the collateral receiver.

FIG. 37 illustrates a screenshot of a collateral provider interface providing the collateral provider the ability to allocate the ULTRA token holdings to the collateral receiver.

FIG. 38 illustrates a collateral receiver GUI screenshot showing a net excess after the collateral provider allocated the ULTRA token holdings to the collateral receiver.

FIG. 39 illustrates a collateral receiver GUI screenshot showing a net deficit after a collateral provider defaulted and has become insolvent.

FIG. 40 illustrates a default GUI screenshot showing the third-party agent changing the status of the collateral provider to default.

FIG. 41 illustrates a GUI screenshot showing the collateral which has been transferred from the collateral provider to the collateral receiver as assets belonging to the collateral receiver after the default.

FIG. 42 illustrates prior art intra-day repo trading.

FIG. 43 illustrates a schematic diagram of the parties and assets involved in an intra-day repo trade on the platform of the present invention.

FIG. 44 illustrates a schematic diagram of the parties and assets involved in CCP netting (clearing) on the platform of the present invention.

FIG. 45 illustrates a screenshot of the platform GUI including an overview of the margin agreements between a collateral provider (MarginCore NYC) and collateral receivers (Bravo Bank, NSCC, and FICC).

FIG. 46 illustrates a screenshot of the platform GUI providing for allocation of assets to meet a margin call.

FIG. 47 illustrates a screenshot of the platform GUI providing a wallet overview.

FIG. 48 illustrates a screenshot of the platform GUI including an overview of the margin agreements between a collateral provider (MarginCore NYC) and collateral receivers (NSCC, Bravo Bank, and FICC).

FIG. 49 illustrates a screenshot of the platform GUI providing for moving assets between agreements.

FIG. 50 illustrates a screenshot of the platform GUI including an overview of the margin agreements between a collateral provider (MarginCore NYC) and collateral receivers (Bravo Bank, NSCC, and FICC).

FIG. 51 is a schematic diagram of a system of the present invention.

### DETAILED DESCRIPTION

The present invention is generally directed to decentralized asset management systems, and more specifically to collateral mobility and management systems.

In one embodiment, the present invention includes a system for collateral mobility and management over at least one distributed ledger network, including at least one computer processor, at least one memory storing computer-readable instructions thereon, a layered blockchain, a net asset pool, a tokenization module operable to tokenize at least one collateral asset, and a collateral module, including a provider function, a receiver function, an agent function, and a conversion order function, wherein the provider function is operable to facilitate deposits of the at least one collateral asset into a collateral pool, withdraw the at least one collateral asset from the collateral pool, allocate the at least one collateral asset, and/or substitute the at least one collateral asset, wherein the receiver function is operable to receive the at least one collateral asset, wherein the agent function is operable to manage the at least one collateral asset, wherein the conversion order function is operable to execute a conversion order between a traditional asset and a digital asset, and wherein the collateral module includes at least one collateral agreement automatically generated from at least one rule, wherein the at least one distributed ledger network is operable to connect to at least one second distributed ledger network, wherein a graph structure is operable to connect the at least one distributed ledger to the at least one second distributed ledger network, wherein the at least one tokenized collateral asset is operable to be transferred from a party to a second party in real time across the distributed ledger networks, wherein the graph structure includes transaction nodes within transfer networks and bridges that connect networks, wherein the transfer of the at least one tokenized collateral asset is based on the at least one collateral agreement, wherein the platform is operable to tokenize any collateral asset, regardless of issuer or protocol, wherein the platform is operable to control the movement of the tokenized collateral asset through self-executing smart contracts, wherein the platform is operable to execute the collateral agreement at any time of day, wherein the platform is operable to interact with any wallet or custody solution, and wherein the platform is operable settle the transfer of the at least one tokenized collateral asset in real-time.

In another embodiment, the present invention includes system for collateral mobility and management over at least one distributed ledger network, including at least one computer processor, at least one memory storing computer readable instructions thereon, a net asset pool, a tokenization module operable to tokenize at least one collateral asset, and a collateral module, comprising a provider function, a receiver function, an agent function, and a conversion order function, wherein the conversion order function is operable to execute a conversion order between a traditional asset and a digital asset, wherein the collateral module includes at least one collateral agreement automatically generated from at least one rule, wherein the net asset pool is operable to execute a withdrawal of the at least one tokenized collateral asset based on the collateral agreement, wherein the at least one distributed ledger network is operable to connect to at least one second distributed ledger network, wherein a graph structure is operable to connect the at least one distributed ledger to the at least one second distributed ledger network, wherein the tokenized collateral asset is operable to be transferred from a party to a second party in real time across the distributed ledger networks, wherein the system is operable to interact with any wallet or custody solution, wherein the system is operable to tokenize any collateral asset, regardless of issuer or protocol, wherein the graph structure includes transaction nodes within transfer networks and bridges that connect networks, wherein the transfer of the at least one tokenized collateral asset is based on the at least one collateral agreement, and wherein the collateral agreement is operable to be executed at any time of day.

In yet another embodiment, the present invention includes a platform for collateral mobility and management over at least one distributed ledger network, including at least one computer processor, at least one memory storing computer-readable instructions thereon, a layered blockchain, a net asset pool, a tokenization module operable to tokenize at least one collateral asset, and a collateral module, comprising a provider function, a receiver function, an agent function, and a conversion order function, wherein the conversion order function is operable to execute a conversion order between a traditional asset and a digital asset, and wherein the collateral module includes at least one collateral agreement automatically generated from at least one rule, wherein the at least one distributed ledger network is operable to connect to at least one second distributed ledger network, wherein a graph structure is operable to connect the at least one distributed ledger to the at least one second distributed ledger network, wherein the graph structure includes transaction nodes within transfer networks and bridges that connect networks, wherein the at least one tokenized collateral asset is operable to be transferred from a party to a second party in real time across the distributed ledger networks, wherein the system is operable settle the transfer of the at least one tokenized collateral asset in real-time, wherein the transfer of the at least one tokenized collateral asset is based on the at least one collateral agreement, wherein the platform is operable to tokenize any collateral asset, regardless of issuer or protocol, wherein the platform is operable to control the movement of the tokenized collateral asset through self-executing smart contracts, and wherein the platform is operable to interact with any wallet or custody solution.

None of the prior art discloses a data structure and platform for collateral mobility and management that is operable to tokenize and transfer collateral assets in real time and across various markets/jurisdictions, and which includes rules which are operable to automatically generate a collateral agreement for governing the transaction.

Distributed ledger technology (DLT) is a decentralized, immutable computer ledger that enables the creation of digital assets. The digitization of assets is advantageous in removing the participation of intermediaries that are typically necessitated in physical issue and transaction of assets. A distributed ledger is a type of distributed database that operates without a central authority and replicates an identical copy to a non-hierarchical network of nodes that communicate with each other over peer-to-peer protocols. The ledger and resulting state of the system is secured from fault through the use of consensus mechanisms that replace the trusted node or central authority used in traditional distributed databases. These consensus mechanisms ensure agreement on an asset during management and transfer of the asset, thereby establishing a data consensus and preventing fault errors.

Distributed ledgers have previously been used to create and manage digital currency, but recent systems have been developed to create digital representations, known as tokens, of both fungible (e.g., currency, gold, oil) and non-fungible assets (e.g., share certificates, crypto art). These tokens are created and transacted on DLT platforms. An advantage of these systems is that the digital assets are operable to be exchanged simultaneously (e.g., asset-for-currency exchange or currency-for-currency exchange) using standardized logic without the need for reconciliation or a central authority. Another advantage inherent in DLT is the ability to decentralize state change authorization decisions. As DLT has evolved, the distributed ledger serves as the foundation for a decentralized computing platform that provides an environment for the execution of programs stored on the ledger.

The various functions of DLT systems are executed by smart contracts, which are executable code stored on a distributed ledger, thereby enabling versatility in DLT systems. However, as the range of applications for DLT has expanded, it has become difficult to manage rights in the various transactions accomplished on the ledger. For example, transactions of financial instruments are highly regulated by various authorities to protect market participants and thereby require a framework of data rights management.

Some prior art systems utilize third-party services, known as oracles, that share data from the off-chain to the smart contracts stored on the DLT (i.e., on-chain). The oracle verifies and authenticates data through trusted Application Programming Interfaces (API). Smart contracts then utilize the information to make decisions. However, the use of oracles alone has not significantly decentralized the creation and sharing of data on-chain, especially the creation and transfer of individual data elements or attestations shared between untrusted smart contracts or assigned by individual or collective end-users.

Decentralized data sharing on a distributed ledger is disclosed in US Patent Publication No. 2022/0271936 and US Patent Publication No. 2024/0007479, each of which is incorporated herein by reference in its entirety.

DLT is powerful based on the concept of Ethereum Requests for Comments (ERC) standards, which are technical standards used to create and manage tokens on the blockchain. Moreover, ERC standards are mechanisms for implementing consistency.

A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership.

However, tokens can support different properties and characteristics, wherein the properties and characteristics have different meanings to different financial institutions. This wide variety of possible standards and schemata presents an issue for financial institutions when the institution wants to transfer and/or transact with the tokenized assets.

Collateral is the backbone of the financial ecosystem, enabling market access, extensions of credit, and the use of derivative markets to hedge risks. If financial institutions cannot access collateral, they cannot engage in the financial market. Today, a financial institution's access to collateral may be contemporarily trapped, preventing the institution from fully participating in the market. Even though the institution has the appropriate collateral, such collateral may be divided across clearing houses, counterparties, and custodians, all with different operating hours, business day conventions, and requirements for moving collateral, all of which makes the process of moving collateral labor-intensive and time-consuming. Additionally, with traditional finance, it is impossible to move collateral after hours. Thus, there is a need for an improved way to transfer collateral in real time, and at any time of day.

Collateral mobility refers to the ability to easily and efficiently transfer collateral assets, such as securities, across different market participants and jurisdictions.

Collateral within traditional finance entails various challenges, including a fragmented market infrastructure, growing complexity, lengthy settlement cycles and inventory trapped by region and product, inventory siloes which prevent optimization, costly, unscalable, and manual processes, stale, incomplete, and batch-driven data, limited resilience in times of stress, and high funding, operations, and technology costs.

Additionally, traditional, existing settlement practices also come with issues of fragmentation across various settlement infrastructures, inability to execute collateral transfers in real-time, data discrepancies, operational delays, and settlement risks such as delivery failure. Financial institutions struggle with delays and risk being bogged down by paperwork and manual processes.

Thus, there is a need for a mechanism for sharing data on chain that is able to manage complex data and data standards. Additionally, there is a need for improved collateral mobility across business and institutions that are not well connected nor utilize the same standards for the collateral, as well as a need for enhanced liquidity of the financial market.

Moreover, many financial firms and institutions have common practices of trading on margins. Margin trading refers to the practice of using borrowed funds from a broker to purchase or trade a financial asset, including securities. In order to borrow the funds, the investor must provide collateral, which is held by a tri-party agent. If the lender requires additional collateral, of which the investor does not own, there is not a current way for the traders to meet the margin call with anything besides cash. Additionally, upon default, a tri-party agent transfers the collateral to the lender, which ensues settlement issues such that the collateral cannot be settled in real-time. Thus, there is a need for a collateral management platform that increases the mobility and velocity of collateral movement globally, increases capital efficiencies and liquidity for all participants, facilitates the convergence of traditional and digital assets, and enables an open digital liquidity ecosystem for market participants to deploy digital applications to enhance collateral operations.

Additionally, there is a need for a digital method of moving, managing, and financing collateral, including all types of assets, such as real-world assets and cryptographic assets.

The platform of the present invention improves upon the drawbacks of traditional finance by using tokenized forms of collateral in a common collateral network connecting market participants, which enables financial institutions to lift unencumbered collateral and instantly pledge it to another central counterparty clearing house (CCP), even after U.S. market hours are over. The platform of the preset invention allows financial institutions to trade and manage risk when the institution needs to, not when their access to the collateral allows the institution to. Additionally, the platform of the present invention utilizes smart contracts which are operable to allow end users to create further automation of collateral movement, which ultimately reduces costs for the financial institution. The platform of the present invention utilizes digital collateral assets, which provide for seamless asset mobility across regions and markets, reduces settlement time from days to minutes, provides for inventory management and optimization, reduces costs, protects from fallouts from volatile market conditions, and provides unprecedented liquidity, efficiencies, scale, and speed. The platform of the present invention provides a single, unified platform for the interaction of any form of value, in any jurisdiction, at any time of day.

Referring now to the drawings in general, the illustrations are for the purpose of describing one or more preferred embodiments of the invention and are not intended to limit the invention thereto.

### Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

### Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

### Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

In one embodiment, the present invention includes a system for collateral mobility and management.

In another embodiment, the present invention includes a method for collateral mobility and management.

In one embodiment, the present invention includes a platform including data structures providing for collateral mobility and management, as described herein, as described herein.

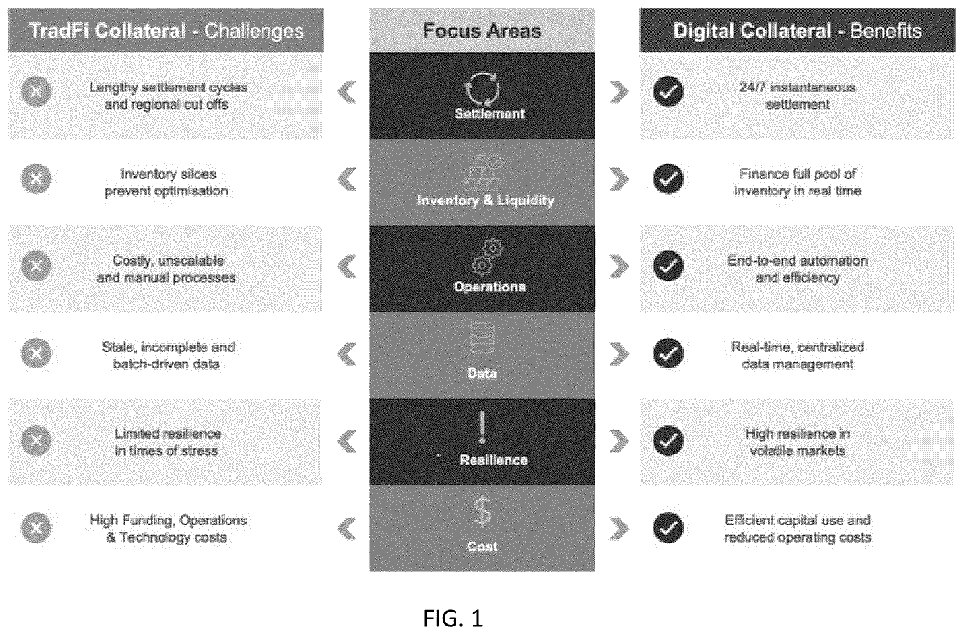

FIG. 1 illustrates the benefits of digital collateral compared to traditional financial collateral. Digital collateral is operable to provide instantaneous settlement, finance full pool of inventory in real time, provide end-to-end automation, real-time, centralized data management, high resilience in volatile markets, and efficient capital use and reduced operating costs. This is in contrast to traditional collateral which requires lengthy settlement cycles and regional cut offs, siloes of inventory which prevent optimization, unscalable and manual processes, stale and incomplete batch-driven data, limited resilience, and high funding, operations, and technology costs.

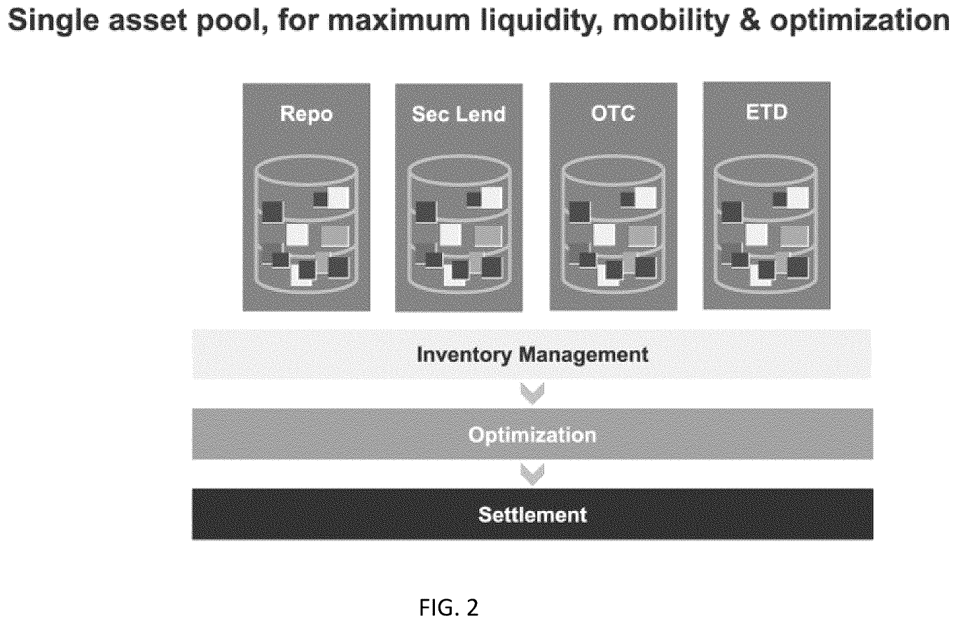

FIG. 2 illustrates the single asset pool of a platform of the present invention, wherein the single asset pool is operable to provide improved inventory management, optimization, and settlement of collateral. The single asset pool provides for execution of repurchase agreements, securities lending, transactions in over-the-counter (OTC) markets, and trading of exchange-traded derivatives (ETD).

In one embodiment, the present invention includes a platform which is operable to facilitate transactions of collateral which include a common data structure for collateral mobility. The platform is operable to span multiple heterogeneous computing networks to accomplish a cross-network transaction, as described in U.S. Application No. 62/388,333, U.S. Application No. 62/839,971, U.S. Pat. Nos. 11,038,718, 12,244,437, US Patent Publication No. 2024/0007329, and US Patent Publication No. 2025/0184178, each of which is incorporated by reference herein in its entirety.

In one embodiment, a custodian is the issuing agent of a digital token for a traditional asset, wherein the underlying security remains in a control account and the token represents the beneficial owner's entitlement.

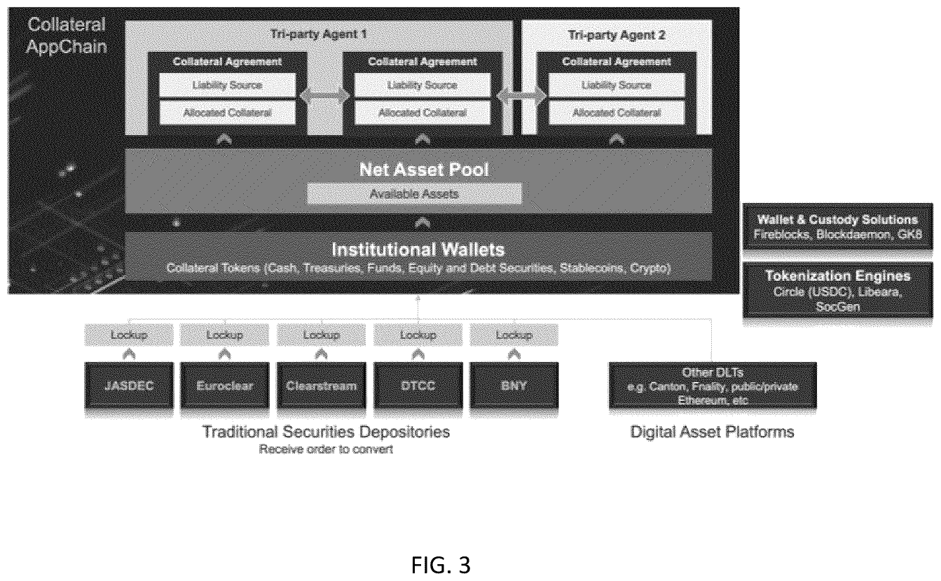

FIG. 3 illustrates a schematic diagram of a platform of the present invention, wherein the platform includes institutional wallets, a net asset pool, and at least one tri-party agent. The platform includes an AppChain or layered chain blockchain for collateral management. In one embodiment, collateral tokens are added into an account abstraction end user operated account, which includes an on-chain smart contract wallet, which enables smart contract logic to be executed for the movement of value, including the collateral tokens. In one embodiment, the net asset pool provides netting of all assets, collateralized trades, and management of locked and collateral value. In one embodiment, the net asset pool includes all functions needed to allocate and recall collateral, including performing substitutions as needed. In one embodiment, the net asset pool is operable to execute a withdrawal of collateral to a collateral agreement, wherein the collateral agreement is associated with at least one rule. In one embodiment, the withdrawal of an asset, including a collateral asset, is managed by smart contract logic. In one embodiment, the net asset pool is a smart contract account abstraction, operable to enable interaction with other smart contracts, such as a collateral agreement or tokenized asset. Advantageously, the platform is operable to utilize account abstraction for automating trading of tokenized assets, permitting the movement of collateral directly between collateral agreements, across markets, custodians, and tri-party agents.

The AppChain is operable to bridge to any legacy system, and connects with other distributed ledgers such as CANTON, FNALITY, and ETHEREUM. In one embodiment, the AppChain is operable to connect to any network, including any private or public layer-1 DLT and traditional custodian systems.

In one embodiment, an asset on a third-party digital asset ledger is wrapped upon entry into the AppChain. For example, Bitcoin is locked on the Bitcoin network, and a wrapped version is minted on the AppChain.

In one embodiment, information is received describing a desired/requested cross ledger transaction that spans at least two dissimilar networks, such as two different DLT networks. A multi-network graph structure is read. The graph structure can be created by crawling nodes corresponding to bridges that span networks. Each node in the graph structure can have an associated set of attribute variables as node metadata. The attribute variables can include units of value (tokens) native to the corresponding network, identification of smart contracts implementing the tokens, wallets or accounts used for bridging, value sources available to the user, and APIs and network interfaces to other networks. Transaction routing information is generated for effecting the transaction by traversing the graph structure in accordance with a node traversing algorithm and detecting bridge nodes that facilitate the desired transaction. A transfer path is selected by the source based on preferences using the transaction routing information and the transfer is initiated. The desired transfer path is operable to include a chained set of sub-transactions that ensures proper execution of the requested cross ledger transaction. Sub-transactions are executed using the specified interfaces to achieve the cross network transaction. Sub-transactions are executed on heterogeneous networks using an ontology mapping that converts syntax-independent execution instructions to specific instructions recognized by the underlying transfer network. The overarching transaction and all sub-transactions are operable to be recorded on a ledger, that may be distinct from the ledgers involved in sub-transactions. The independent ledger is operable to utilize zero knowledge proofs to provide immutability while maintaining transaction privacy. Note that the chains of sub-transactions can include transactions in the source network, the destination network and other networks that serve as connections between the source network and destination network.

In one embodiment, the AppChain of the platform is operable to work with any tokenization protocol. In one embodiment, the AppChain of the platform is operable to use any wallet or custody provider, thereby providing flexibility and resilience and permitting a user o choose any preferred wallet solution.

In one embodiment, a collateral agreement controls the facilitation and transfer of collateral assets on the platform. In one embodiment, the terms of a collateral agreement constitute the rules for a transaction under the agreement. In one embodiment, the terms of a collateral agreement are determined by at least one user. In one embodiment, the terms of a collateral agreement are determined by a collateral provider and a collateral receiver. In one embodiment, the collateral agreement includes, but is not limited to, eligibility of collateral, margin call thresholds, maturity date requirements, minimum haircuts, collateral allocation requirements, right of substitution(s), closeout terms, liquidation terms, minimum collateral value, haircut percentages, termination currency, and/or authorization of rehypothecation. In one embodiment, eligibility of collateral includes eligible and/or ineligible collateral. In one embodiment, eligible collateral includes, but is not limited to, securities, including U.S. treasury bills, notes or bonds, mortgage-backed securities, and/or cash. In one embodiment, eligibility of collateral is determined based on the maturity date of a collateral asset. In one embodiment, eligibility of collateral is determined based on a valuation date of a collateral asset. In one embodiment, eligibility of collateral is determined based on a rating of a collateral asset. In one embodiment, the collateral agreement includes a collateral eligibility schedule reflecting eligible collateral.

Collateral agreements are operable to be executed at any time of day, with collateral being tokenized and operable to be transferred or pledged from one party to another party in real time or near real time, even when markets for the relevant collateral are closed. The platform of the present invention is operable to interact with any wallet or custody solution (e.g., FIREBLOCKS, BLOCKDAEMON, GK8, etc.).

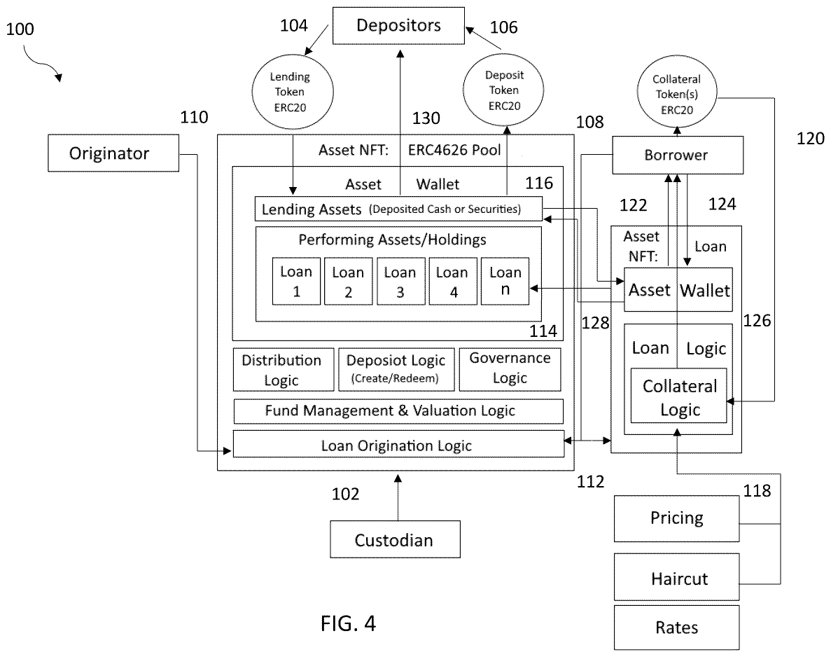

FIG. 4 illustrates a schematic diagram of a securities lending system 100 of the present invention. In one embodiment, a custodian creates and/or configures an asset pool 102. In one embodiment, depositors stake the lending asset, wherein depositors send the lending asset to a fund (pool) 104, wherein the fund shares (deposit receipts) are minted and sent 106. In one embodiment, a borrower requests a loan with terms 108. In one embodiment, an originator approves and issues the loan 110, wherein a loan NFT asset is created 112, wherein the loan NFT asset is placed into a fund wallet 114, and wherein the lending assets are placed in a loan wallet 116. In one embodiment, a borrower initiates the loan by posting collateral, wherein the collateral requirements are obtained and based on credit support annex (CSA), price, and/or haircut 118, wherein the collateral is provided against the loan 120, wherein receipt is taken of the lending assets 122. In one embodiment, a borrower repays the loan with interest, wherein the lending asset is sent to the loan 124, wherein the collateral is released to the borrower 126, wherein the loan principal and the interest is released to the fund 128. In one embodiment, the distributions are paid to the depositors 130.

In one embodiment, the securities lending system 100 is advantageously interoperable with any token, wherein the securities lending system 100 can be executed using any tokenized asset, regardless of issuer and protocol.

In one embodiment, a core account abstraction is used to allow a token to operate a wallet, which advantageously provides for fully automated treasury management for an asset, as well as for funds, loans, and other financial instruments. In one embodiment, fund logic is added, wherein logic expected for all pooled capital including corporate actions, valuation, distribution execution, and other asset governance is used, allowing for simple handling of complex variations of real-world finance, while also creating reusable and predictable patterns for interactions between basic financial instruments. In one embodiment, loan securitization and origination logic specific to the operation of a lending pool is plugged in, which does not require coding knowledge. In one embodiment, one or more share classes are attached to the asset, linking a non-fungible token (ERC721) to one or more fungible tokens (ERC20), advantageously allowing for mezzanine structures, multi-series share classes, representing various governance and distribution rights. In one embodiment, the linkage between lending and deposit receipt tokens automates the minting of shares on deposit, or creating a primary market order, and burning of shares on withdrawal (redeem order). In one embodiment, a loan template is composed, wherein the template is started with a basic account abstraction used to automate loan payment processing and other transactions. In one embodiment, the loan template is operable to be configured to represent a repurchase agreement (repo), securities loan, or a mortgage. In one embodiment, loan tokens instantiating the loan template are minted by the lending pool upon loan origination. In one embodiment, collateral management capabilities are injected into the loan template, thereby gaining tri-party capabilities, including valuation, default processing, collateral swaps, CSA enforcement, netting, and optimization.

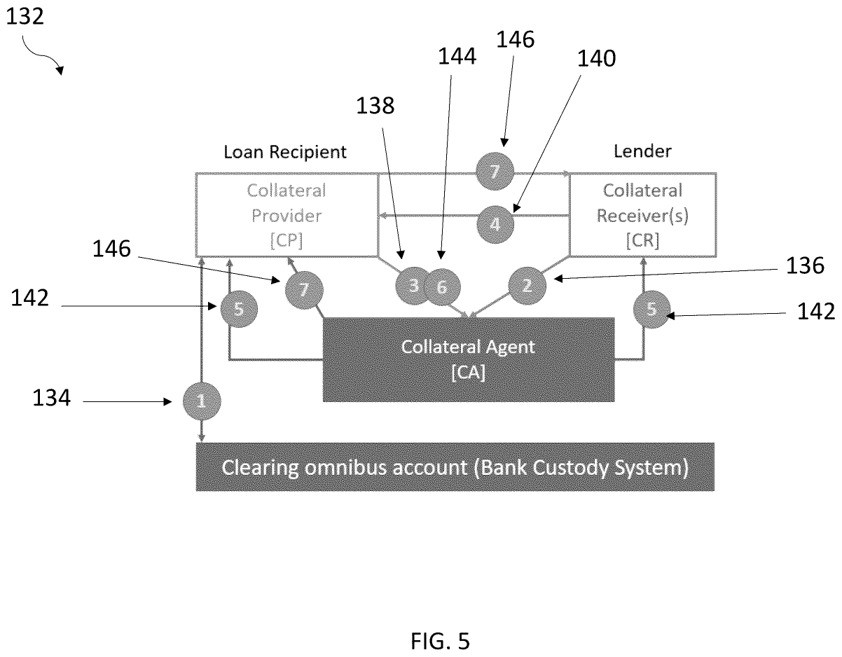

FIG. 5 illustrates a schematic diagram of a tri-party collateral securities lending system 132 of the present invention. In one embodiment, a collateral provider, collateral agent, or other agent tokenizes assets to be used as collateral 134. In one embodiment, a collateral receiver instructs the agreed collateral amount, as well as with agreed upon terms including collateral eligibility criteria 136. In one embodiment, the collateral eligibility criteria is a credit support annex (CSA). In one embodiment, the collateral provider posts the required collateral to the collateral agent, thereby signaling transaction release 138. In one embodiment, upon the transaction release 138, the collateral receiver delivers the loaned assets to the collateral provider 140. In one embodiment, the collateral agent conducts collateral valuation and reporting 142, wherein margin calls are netted if required, wherein distributions are forwarded to the collateral provider. In one embodiment, suitable collateral substitution may be allowed 144. In one embodiment, the collateral agent unwinds the collateral at maturity and/or repayment or forwards on default 146.

In one embodiment, all collateral is maintained in a collateral agent client omnibus account, wherein no movements are affected at market level, wherein collateral ownership is maintained on the distributed ledger with wallets and smart contracts governing movement of the collateral.

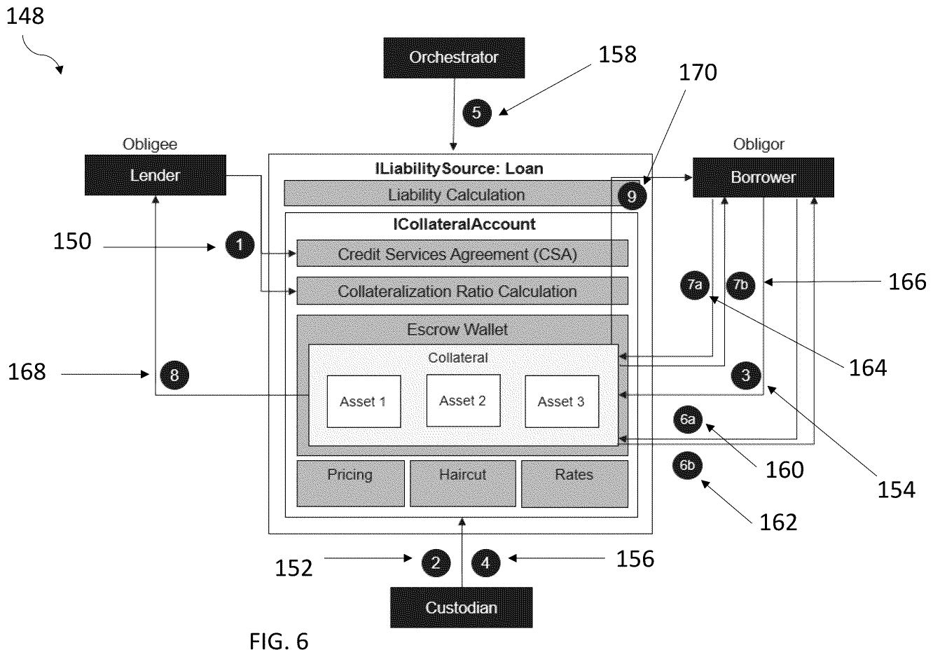

FIG. 6 illustrates a schematic diagram of a collateral-specific securities lending system 148 of the present invention. In one embodiment, a lender issues an obligation, such as a loan, which includes ICollateralAccount logic and sets parameters for the obligation 150. In one embodiment, rates, terms, and rules of the transaction are set by a custodian, including, but not limited to, pricing, haircut, and/or interest rates 152. In one embodiment, the rules of the transaction are enforced by a self-enforcing smart contract. In one embodiment, the rules of the transaction are governed by the self-enforcing smart contract. In one embodiment, the rules automatically generate a credit service agreement, wherein the agreement is embedded in the collateral object.

Providing scalable compliance for transactions of tokenized assets and enforcing a ruleset for decentralized financial transactions is disclosed in U.S. Pat. Nos. 12,361,488 and 11,410,235, each of which is incorporated herein by reference in its entirety. Decentralized asset management, including creating a trusted data management model in a decentralized network is disclosed in US Patent Publication No. 2022/0271936 and US Patent Publication No. 2024/0007479, each of which is incorporated herein by reference in its entirety.

In one embodiment, an obligor posts the collateral 154, wherein the loan is initialized if collateral conditions are met. In one embodiment, the custodian regularly updates the price and/or haircut information 156. In one embodiment, an orchestrator processes interval calculations 158, wherein the interval calculations include calculating liability, collateral value, collateralization ratio, under/over collateralization, increment/reset counter if collateralization is not met, and/or an event upon default conditions being reached. In one embodiment, the obligor meets the updated collateral requirements, wherein collateral is sent if under collateralized 160, wherein collateral is retrieved if over collateralized 162. In one embodiment, the obligor executes collateral substitution, wherein new collateral is sent 164, wherein swapped collateral is received 166. In one embodiment, on default, the collateral is forwarded to an obligee 168. In one embodiment, the collateral is returned to the obligor upon completion 170.

In one embodiment, in the event of a default by a collateral provider, the pledged tokens are transferred from the collateral agreement smart contract to the collateral receiver's digital wallet, wherein once received by the collateral receiver, the tokens can be used to meet other obligations, transferred to another network, or burned in exchange for the underlying real-world asset.

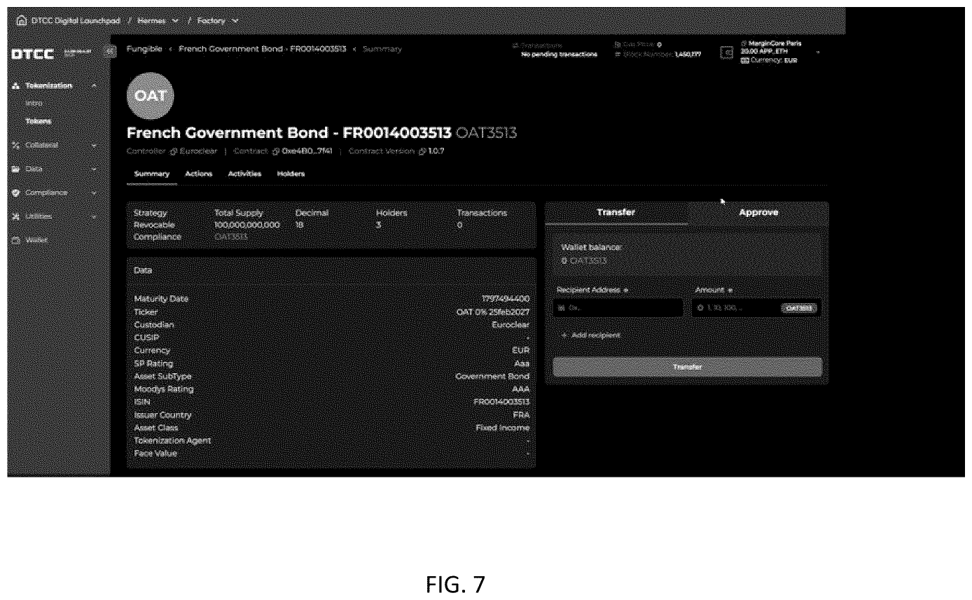

FIG. 7 illustrates a tokenized French government bond on the platform according to one embodiment of the present invention. The platform is operable to enable financial institutions to transact with digital assets in any jurisdiction. Tokenized bonds are operable to be transferred to a recipient through the platform, with the platform being operable to receive a recipient address and amount of the tokenized bonds to transfer to a recipient. In one embodiment, the platform offers a plurality of functions, including tokenization, collateral, data functions, compliance, utilities, and wallet functions. In one embodiment, the collateral functions are divided into provider functions, receiver function, agent functions, and conversion order functions. In one embodiment, the provider function is operable to facilitate a deposit of at least one collateral asset into a collateral pool, withdraw at least one collateral asset from the collateral pool, allocate at least one collateral asset, and/or substitute at least one collateral asset. In one embodiment, the provider function is operable to allocate at least one collateral asset to a receiver. In one embodiment, the receiver function is operable to receive at least one collateral asset allocated from a provider net asset pool. In one embodiment, the receiver function is operable to accept assets as collateral. In one embodiment, the receiver function is operable to access all collateral agreements associated with the receiver, including the agreement name, agreement type, collateral provider, collateral agent, start date, end date, agreement currency, collateral value, collateral amount required, and excess or deficit for each agreement. In one embodiment, the receiver function is operable to provide and access a net excess after a collateral provider allocates collateral assets to the receiver. In one embodiment, the agent function is operable to manage at least one collateral asset. In one embodiment, the agent function is operable to facilitate transfer of collateral from a provider to a receiver. In one embodiment, the agent function is operable to facilitate transfer of collateral from a provider to a receiver after default by a provider. In one embodiment, the agent function is operable to change and/or update a status of a collateral asset. In one embodiment, the conversion order function is operable to execute a conversion order between a traditional asset and a digital asset. In one embodiment, the conversion order function is operable to execute a transaction and/or a conversion for digital and/or traditional form assets. In one embodiment, the conversion order function is operable to provide a list of assets, including securities and bonds. In one embodiment, the conversion order function is operable to facilitate selection of at least one asset and conversion of the at least one asset from a first party to a second party.

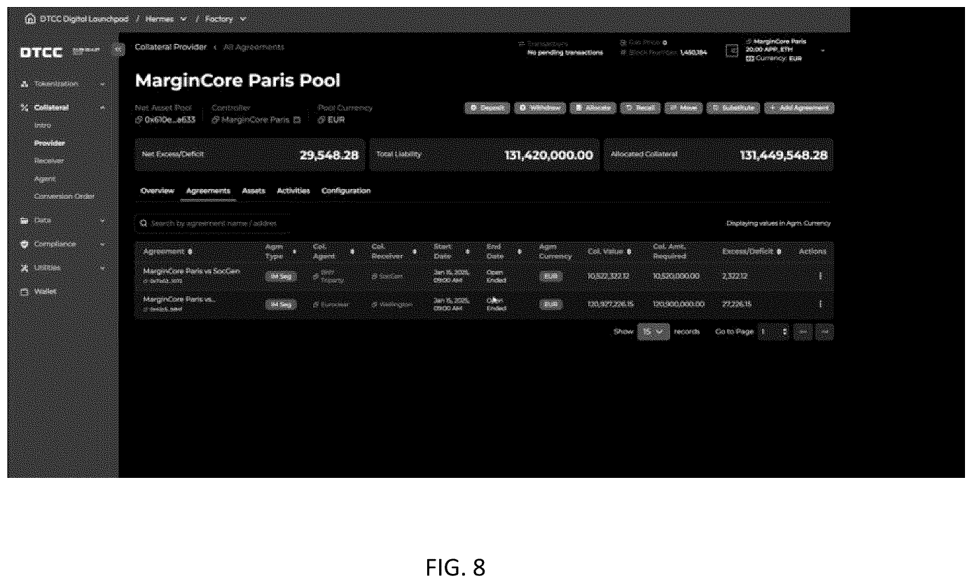

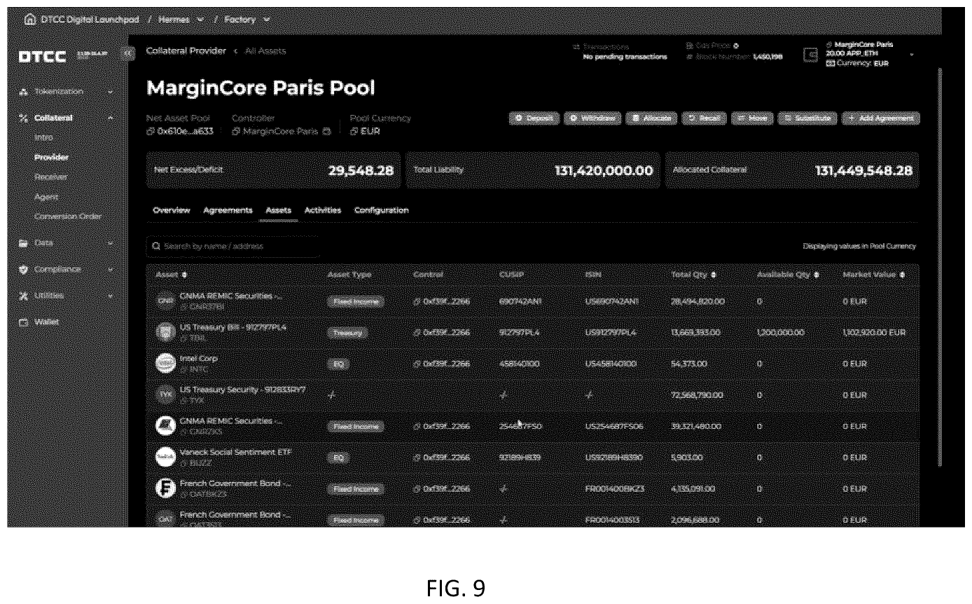

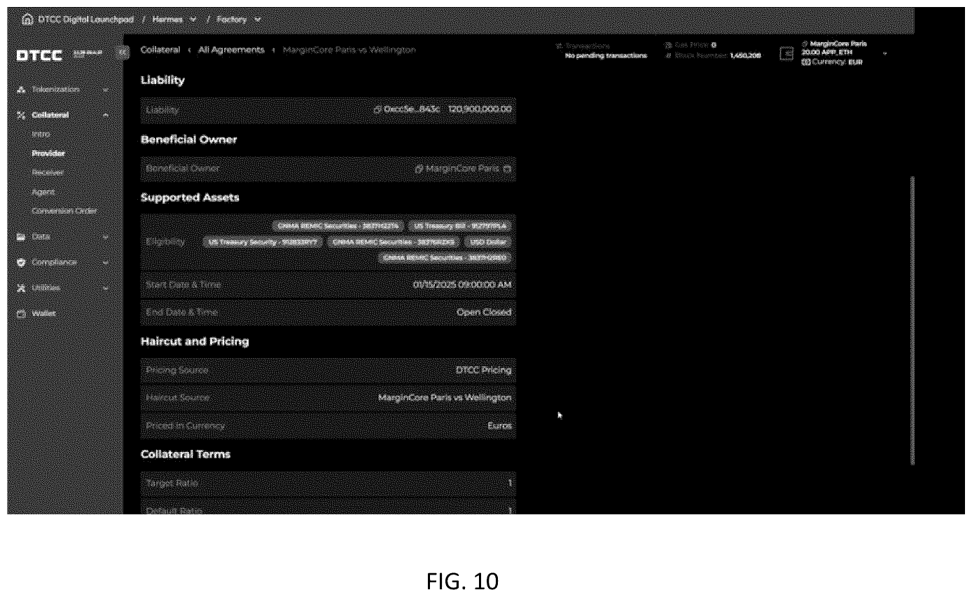

FIGS. 8-10 illustrate the provider collateral functions of the platform according to one embodiment of the present invention. The platform allows for input from a provider to facilitate deposits of assets into a collateral pool, withdraw assets from a collateral pool, allocate assets, and substitute assets. In one embodiment, the platform is operable to manage collateral agreements. In one embodiment, the platform is operable to transfer value directly between custodians in real-time. FIG. 8 illustrates a net excess/deficit, a total liability, and a total allocated collateral for an asset pool. Agreements and identification of other parties are provided through the platform, including collateral agents and collateral receivers. The assets in the asset pool and history of activities are also accessible through the platform. Agreements are operable to be received by the platform in real time or near real time, and assets are operable to be deposited into the pool or withdrawn from the pool in real time or near real time. FIG. 9 is a graphical user interface (GUI) screenshot of a list of assets, including asset type and other asset information. FIG. 10 is a GUI screenshot of the details for a collateral agreement, including the liability, the beneficial owner, supported assets, the start date of the agreement, the end date of the agreement, the pricing source and haircut source, and collateral terms.

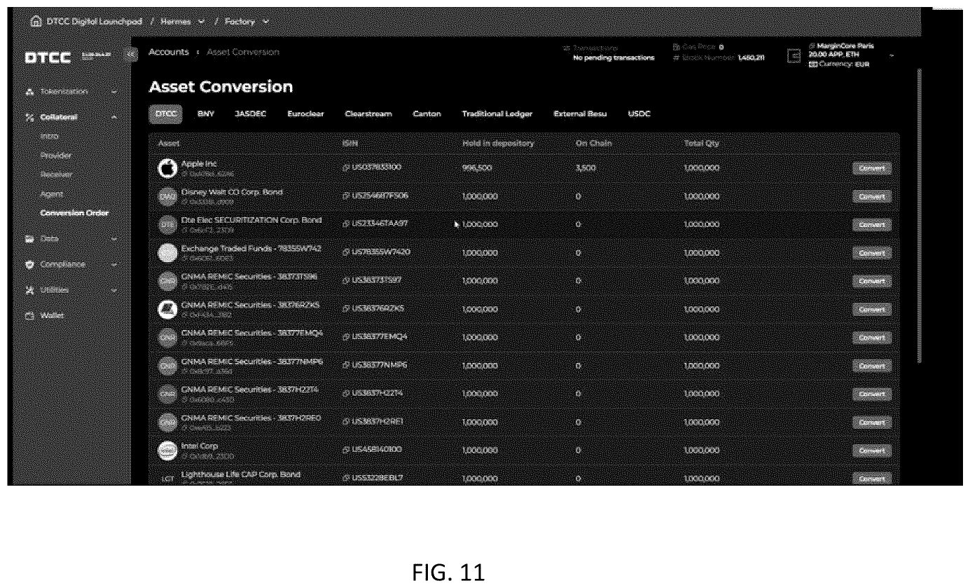

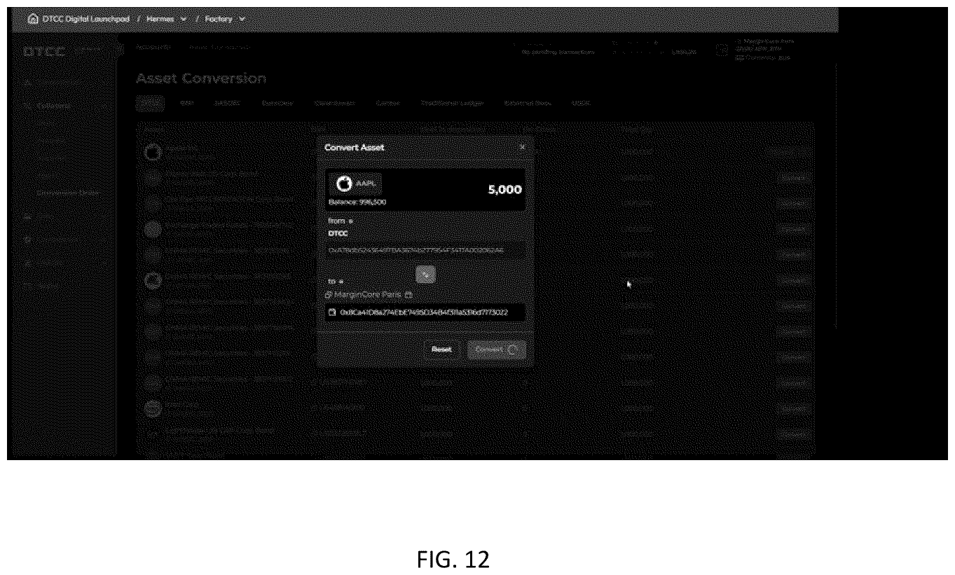

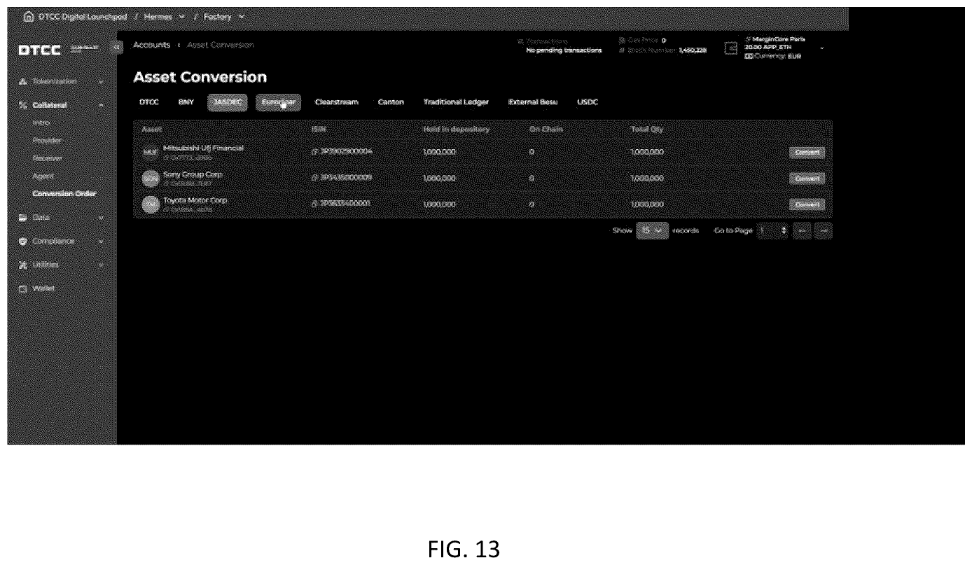

FIGS. 11-13 illustrate a conversion order executed by the platform, according to one embodiment. In one embodiment, the platform is operable to execute a conversion order through the conversion order function, wherein the platform is operable to execute a transaction and/or a conversion for digital and/or traditional form assets. A list of assets is presented in the GUI screenshot of FIGS. 11 and 13, including securities and bonds. The platform is operable to facilitate selection of these assets and conversion of the assets from a first party to a second party, as shown in FIG. 12. In one embodiment, the platform is operable to generate a digital twin of the asset on chain, and is further operable to deliver the digital twin of the asset to the applicable wallet. In one embodiment, the platform is operable to transfer assets to any custodian at any time of day, in real-time.

In one embodiment, the platform is operable to permit and support rehypothecation of tokenized collateral assets, so long as the rehypothecation is authorized within a collateral agreement for a tokenized collateral asset.

### Platform Functionality Examples and use Cases

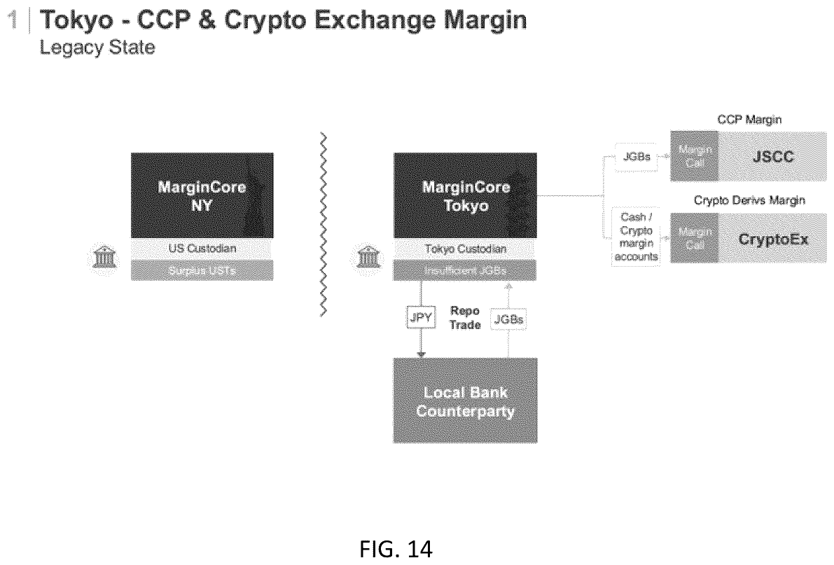

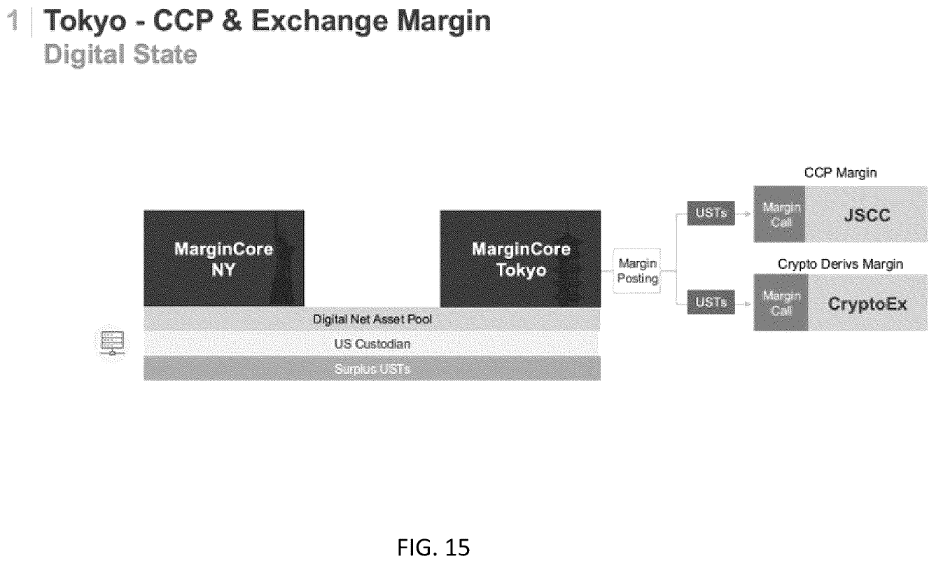

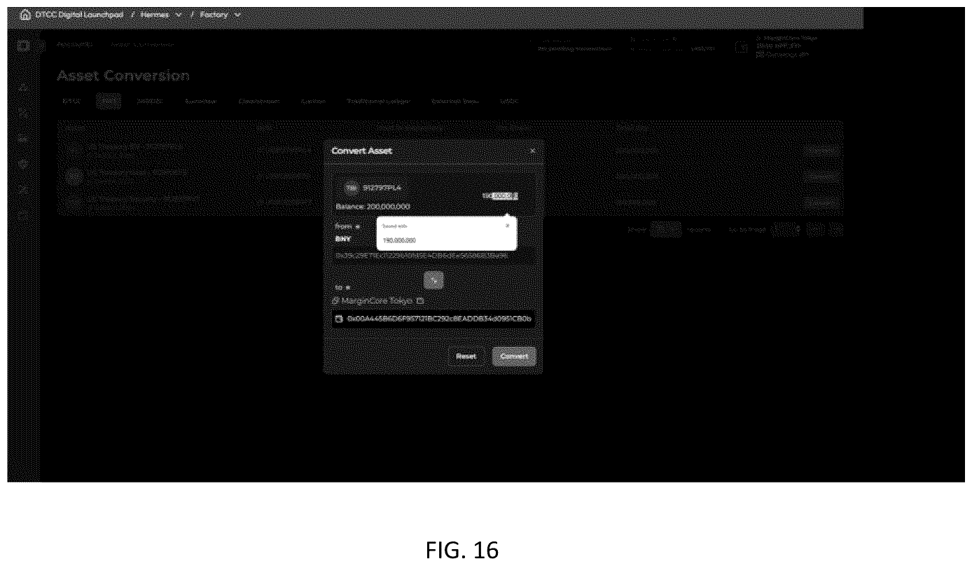

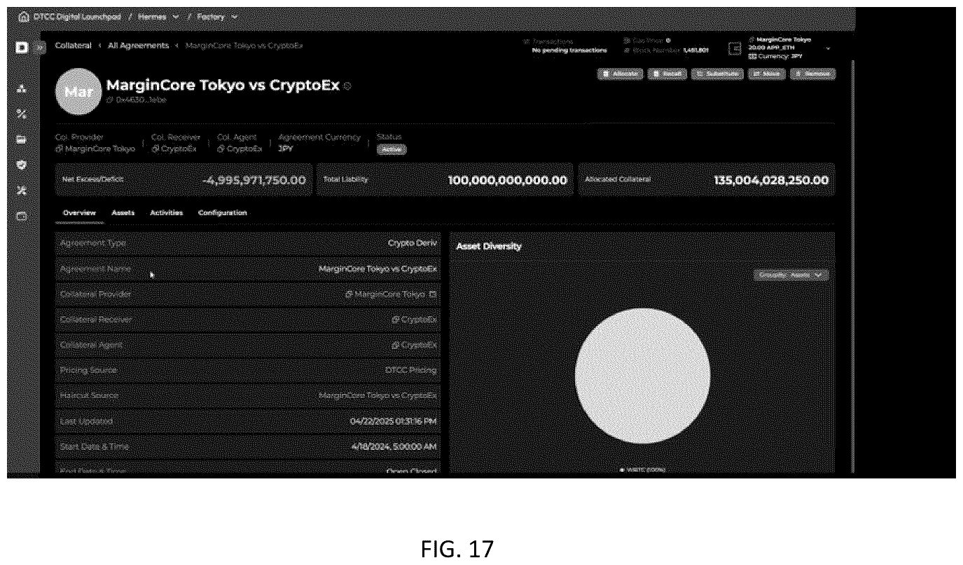

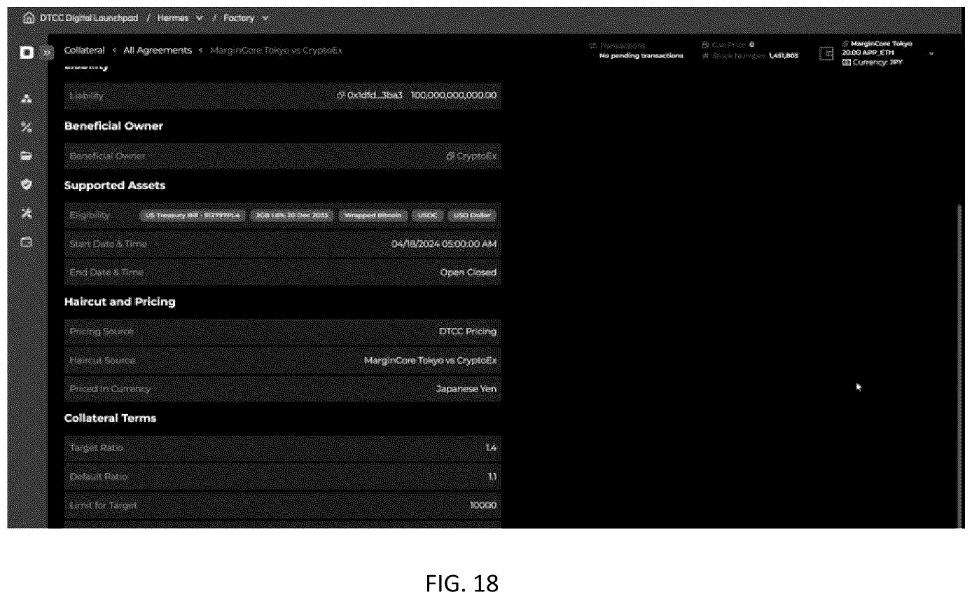

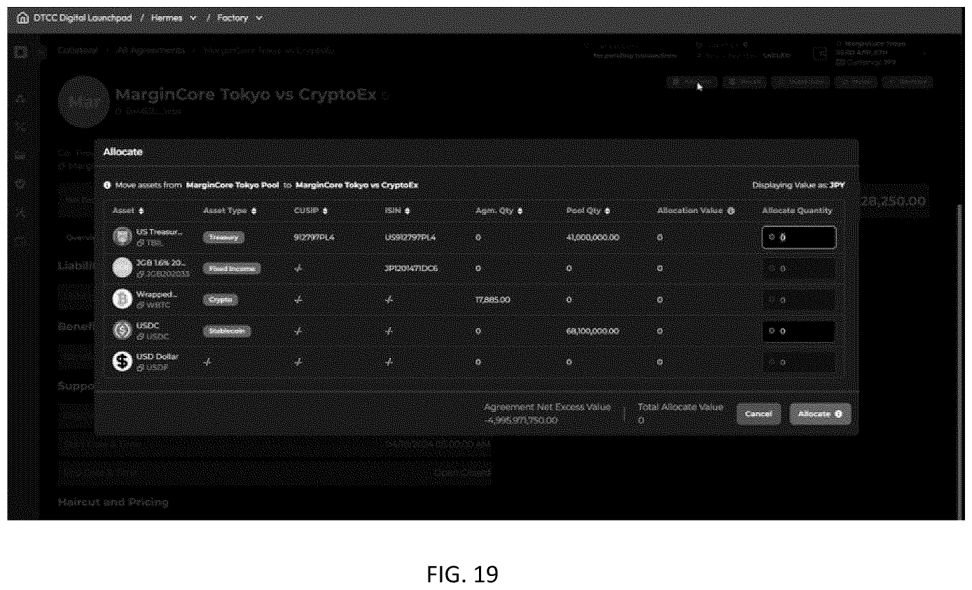

In one embodiment, the platform is operable to access and source collateral, wherein the platform is further operable to settle the collateral in real-time. FIG. 14 illustrates a prior art CCP and crypto exchange margin. FIG. 15 illustrates a schematic diagram of the parties and assets involved in a margin call on the platform of the present invention. FIG. 16 illustrates a screenshot showing a conversion of an asset from one party (BNY) to a second party (MarginCore Tokyo). FIGS. 17-18 illustrate an overview of a margin agreement between a collateral provider (MarginCore Tokyo) and a collateral receiver (CryptoEx). The agreement indicates the net excess/deficit, as well as the total liability and the allocated collateral. The margin agreement includes an agreement type, name, collateral agent, pricing source, haircut source, date the agreement was last updated, a start date/time, and an end date/time. The screenshot of the GUI showing the details of the margin agreement also includes a pie chart of the asset diversity. The agreement includes supported assets, the currency for the agreement, and collateral terms. FIG. 19 illustrates a screenshot of the platform GUI providing for allocation of assets to meet a margin call according to one embodiment of the present invention. Only assets which are eligible to be used to meet the margin call are displayed on this allocation page. In one example, a financial institution (MarginCore Tokyo) has insufficient Japanese Government Bonds (JGBs) to cover a margin call, such that the financial institution needs to source additional collateral. The platform of the present invention is operable to source additional collateral, U.S. collateral assets, even though the U.S. market is not open, wherein the platform is operable to convert the U.S. collateral assets wherein the platform is further operable to place the converted U.S. collateral into the financial institution's digital wallet.

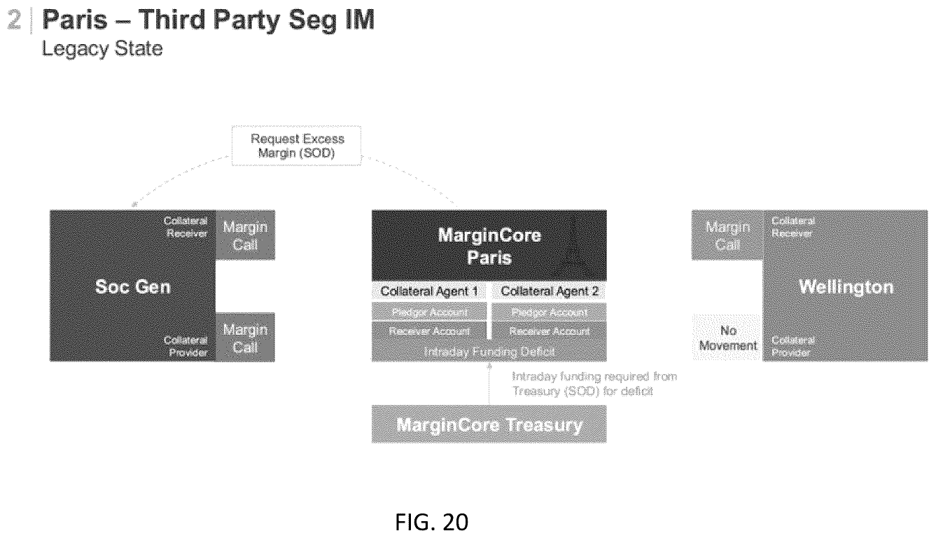

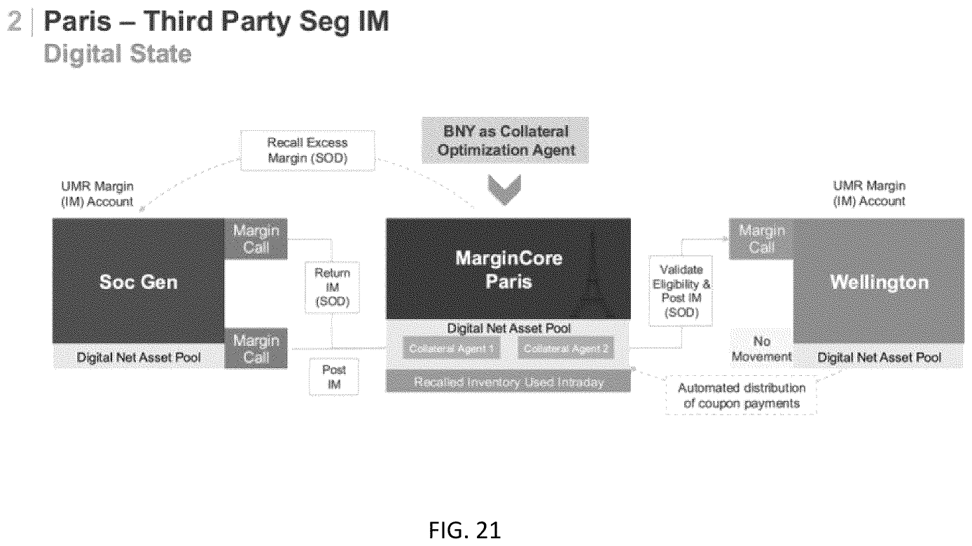

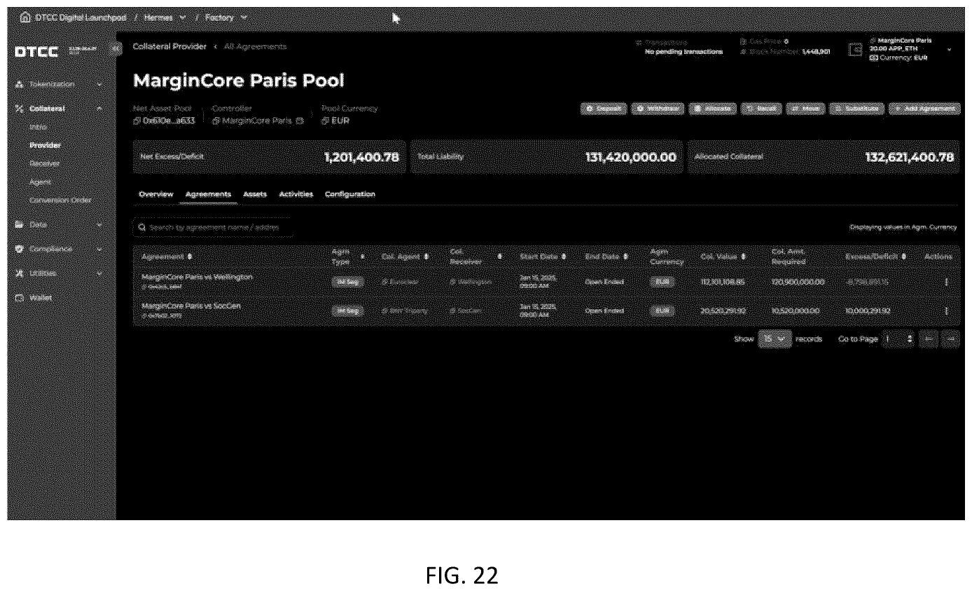

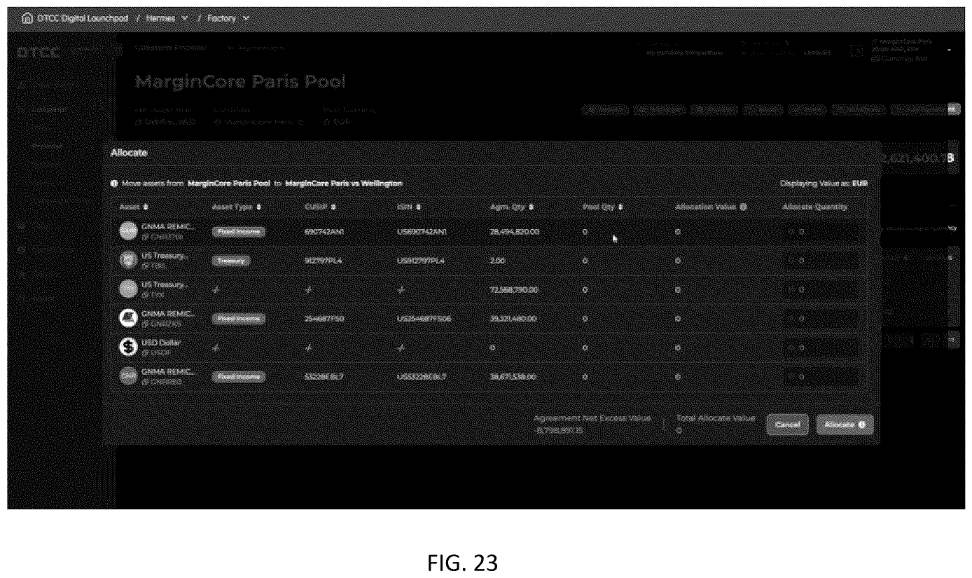

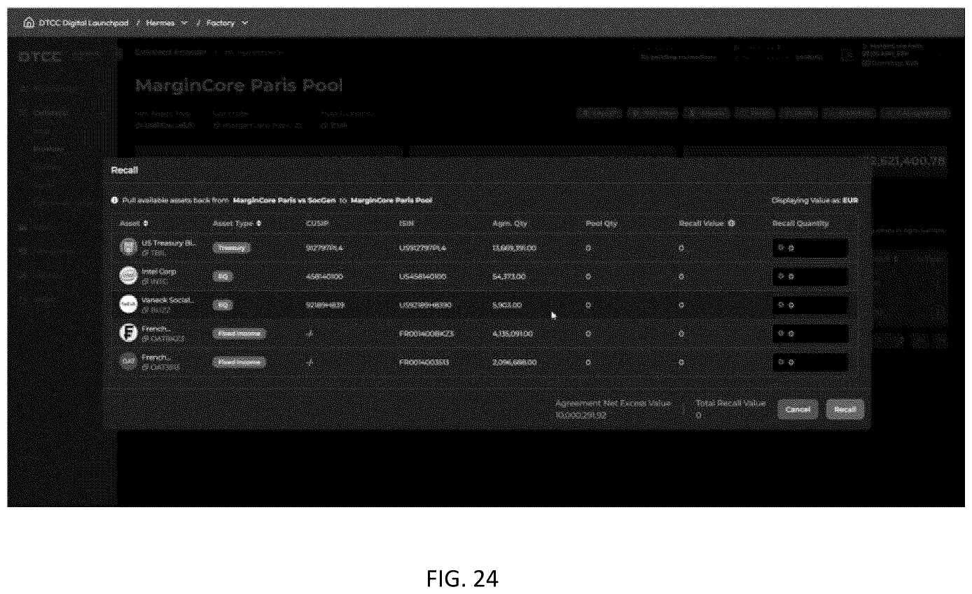

In one embodiment, the platform is operable to access and source collateral, wherein the platform is further operable to re-allocate collateral to satisfy a deficit. FIG. 20 illustrates the parties, actions, and accounts for a third-party segregation of initial margin according to according to a legacy prior art system. The legacy prior art system does not provide for movement of collateral in near real time or in real time but instead must be moved at the end of the day, causing additional money to need to be raised to address a deficit. Additionally, a coupon paid for a bond held as collateral under a legacy system may be paid to the incorrect party depending on the terms of the repurchase agreement. The platform of the present invention solves these problems of the prior art, providing for real-time or near real-time movement of collateral and smart contracts to determine which party receives a coupon payment. For example, if a tokenized asset is pledged as collateral to a second party, the first party is entitled to the coupon payment and receives the coupon payment upon execution of a smart contract implemented on the platform of the present invention. The platform of the present invention provides for recalling excess margin from a first receiver by reallocating collateral from the first receiver to a second receiver to which additional collateral is desired to be allocated, such as if the second receiver has made a margin call. FIG. 21 illustrates the parties, actions, and accounts for a third-party segregation of initial margin according to one embodiment of the present invention. FIG. 21 also illustrates the automated distribution of coupon payments to the appropriate party using the platform of the present invention. FIG. 22 illustrates a GUI screenshot of agreements for a collateral pool according to one embodiment of the present invention. The net excess/deficit, total liability, and allocated collateral are indicated. FIG. 23 illustrates a list of assets which are available to be allocated from the collateral pool to a receiver of collateral. Upon receiving an identification of one or more assets, the platform is operable to allocate the assets from the collateral pool to be pledged to a receiver as collateral for a margin. FIG. 24 illustrates recall functionality for the platform, providing the ability to recall assets which were previously pledged to a receiver to the asset pool. The GUI screenshot of FIG. 24 illustrates the net excess value pledged to the receiver, and a total current recall value based on the assets selected for recall.

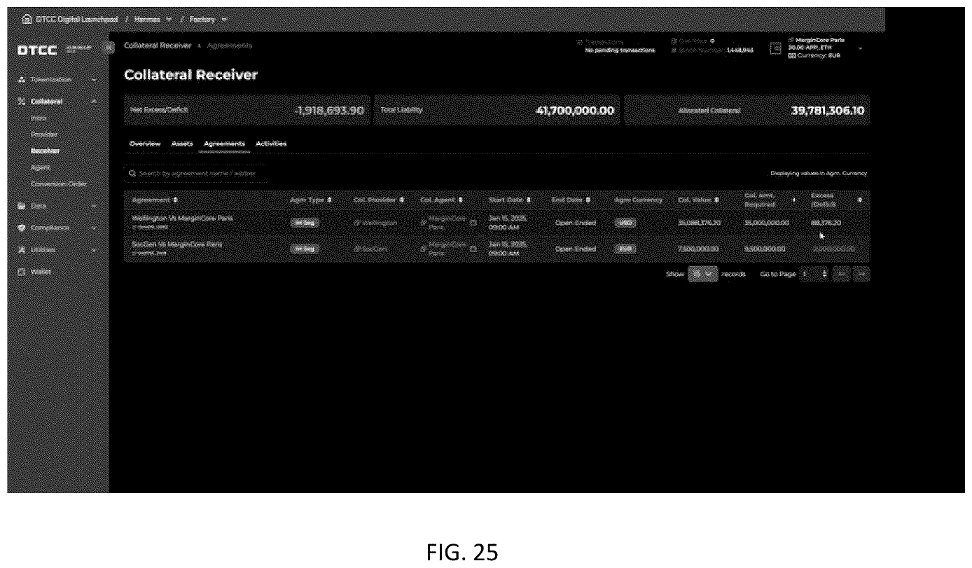

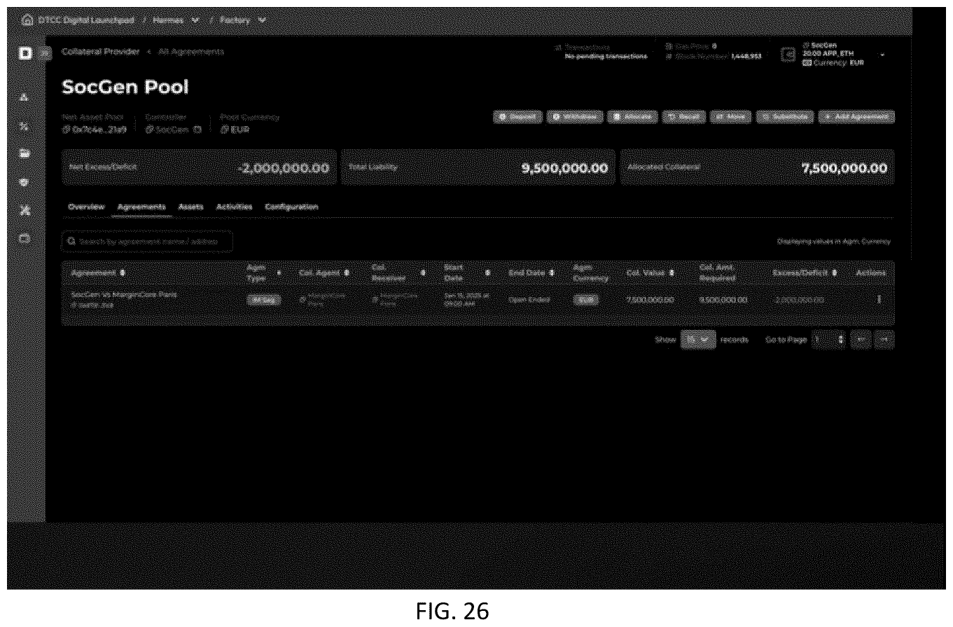

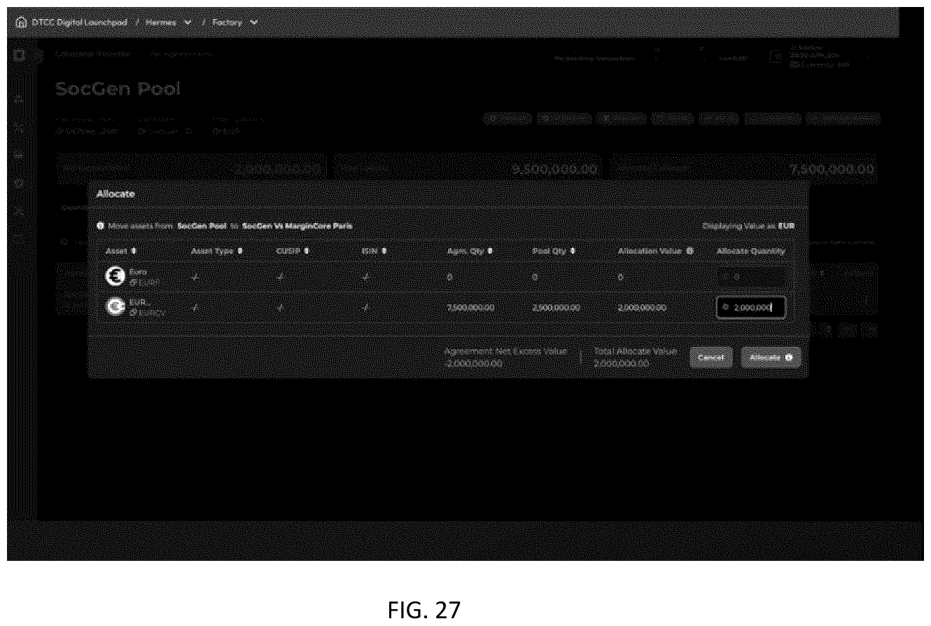

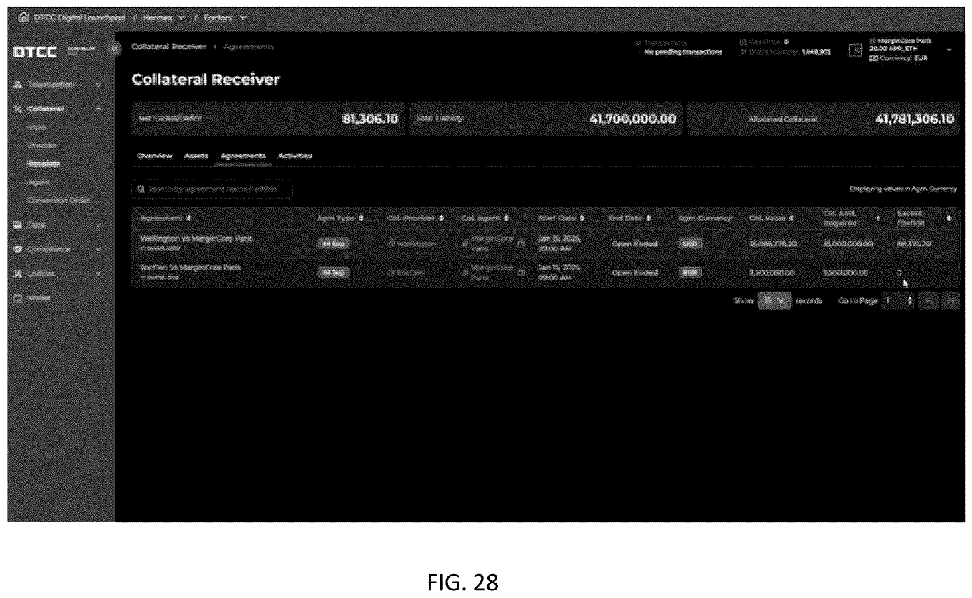

FIG. 25 illustrates a GUI screenshot of the platform available to the collateral receiver, including an overview tab, assets tab, agreements tab, and activities tab. The collateral receiver has a net deficit, with the total liability exceeding the total allocated collateral. The agreements tab shown in FIG. 25 lists the agreements for the collateral receiver, including the agreement name, agreement type, collateral provider, collateral agent, start date, end date, agreement currency, collateral value, collateral amount required, and excess or deficit for each agreement. FIG. 26 is a GUI screenshot for a collateral provider, showing the agreement for the collateral provider, as well as the agreement type, collateral agent, collateral receiver, start date, end date, agreement currency, collateral value, collateral amount required, and excess or deficit for the agreement. FIG. 27 illustrates allocation functionality for allocating assets from the provider pool to a receiver. The available assets are filtered by assets which are permitted to be pledged as collateral under the relevant collateral agreement. FIG. 28 illustrates a GUI screenshot after allocation has occurred, showing a net excess for the collateral receiver with more allocated collateral than total liability. Traditionally, collateral movements cannot be conducted until the end of the day and movement across collateral agents is traditionally inefficient. In one embodiment, the platform includes a single asset pool, advantageously providing for improved optimization including quick settlement of collateral. In the example shown in the GUI screenshots, a financial institution (MarginCore Paris) has excess collateral from Soc Gen and a deficit in the margin call from Wellington. The financial institution requests excess margin (SOD) from Soc Gen and reallocates the collateral to Wellington to cover the margin call, all of which is performed on the platform of the present invention.

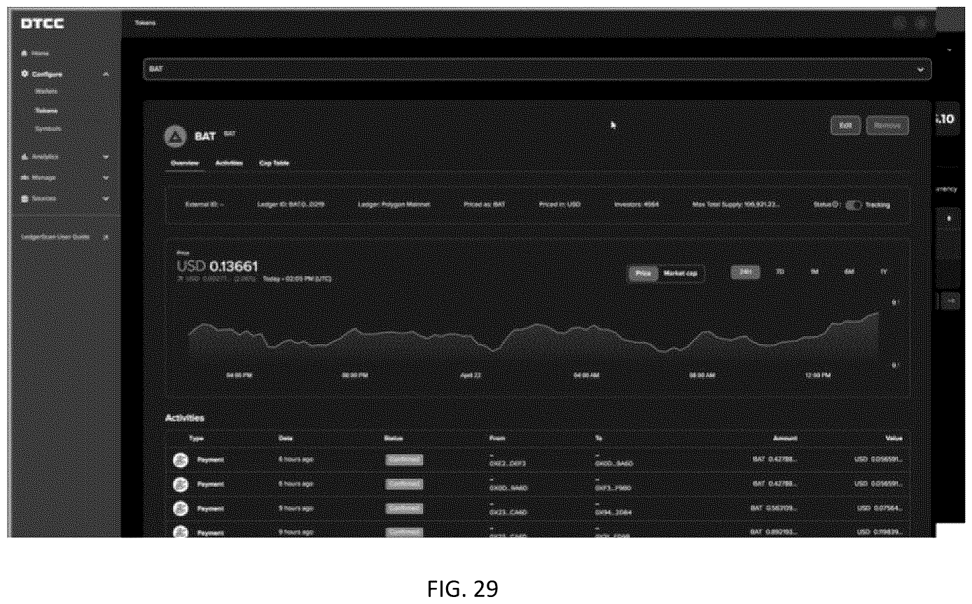

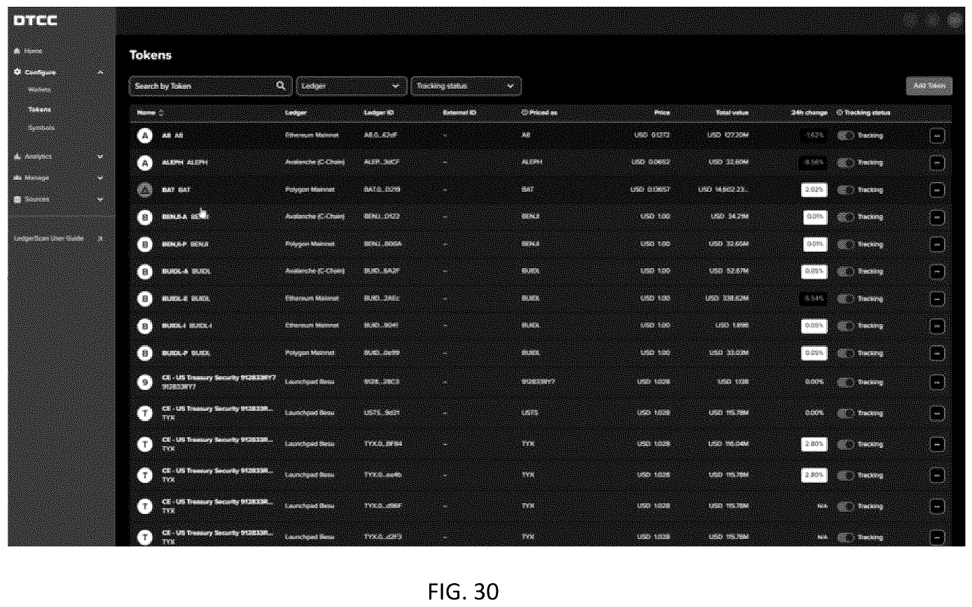

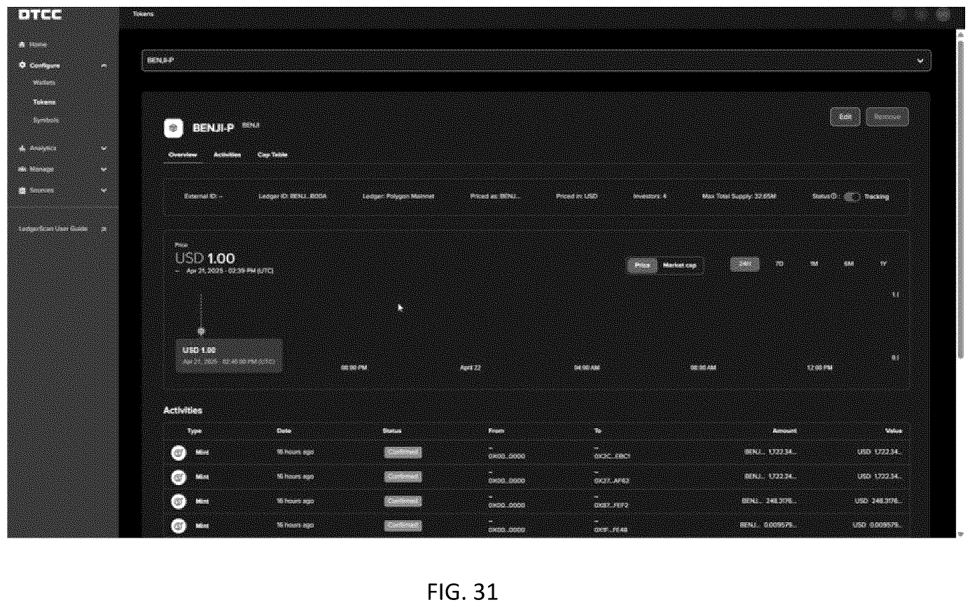

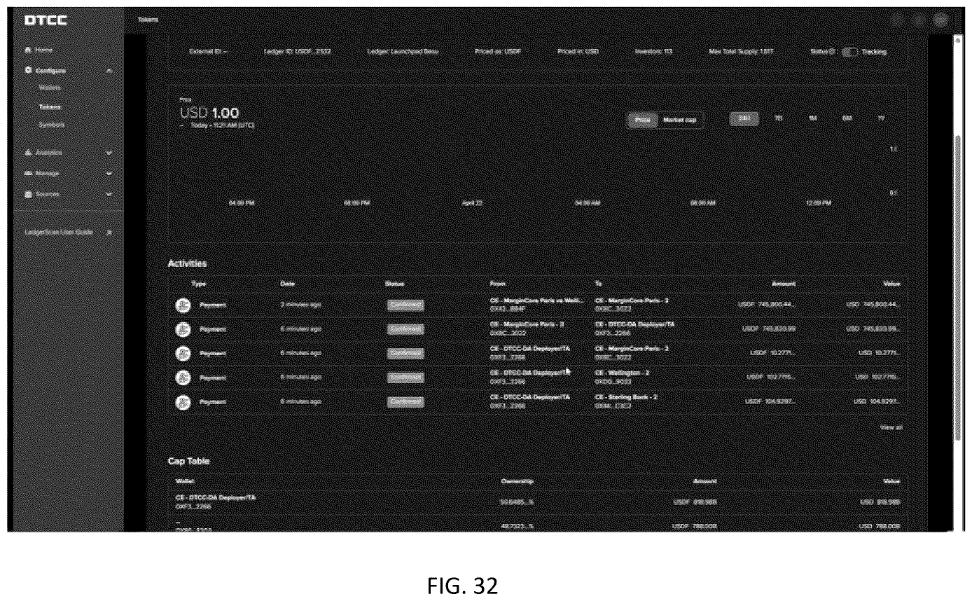

In one embodiment, the platform is operable to track activity on distributed ledgers and/or traditional systems, in real-time. In one embodiment, the platform is operable to consolidate data on and off chain. In one embodiment, the platform is operable to integrate with existing accounting and financial systems. In one embodiment, the platform is operable to track all on chain activity, all wallet activity, and/or any distributed ledger activity. FIG. 29 illustrates a GUI screenshot of information for a Basic Attention Token (BAT) token, including an overview of the token, the price of a token, and activities associated with the token. FIG. 30 illustrates a GUI screenshot of multiple tokens for which the platform retrieves up to date information, including price, total value, percentage change over 24 hours, and whether or not the token is being tracked. FIGS. 31-32 illustrate an overview of the BENJI-P token. The platform is operable to track movement of the USD distribution through the CE-USDF token, wherein the platform is operable to show the distribution and/or movement between wallets in real-time.

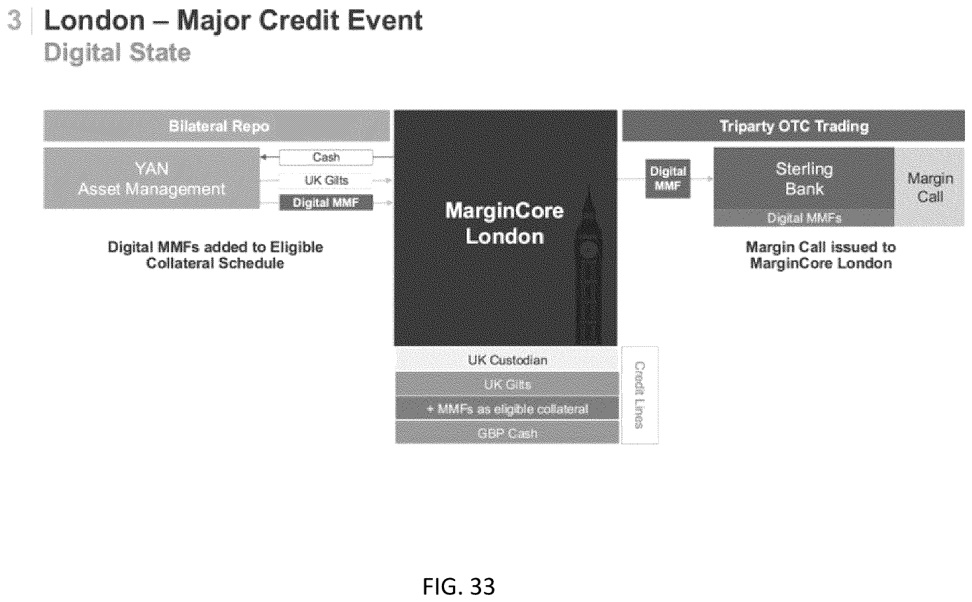

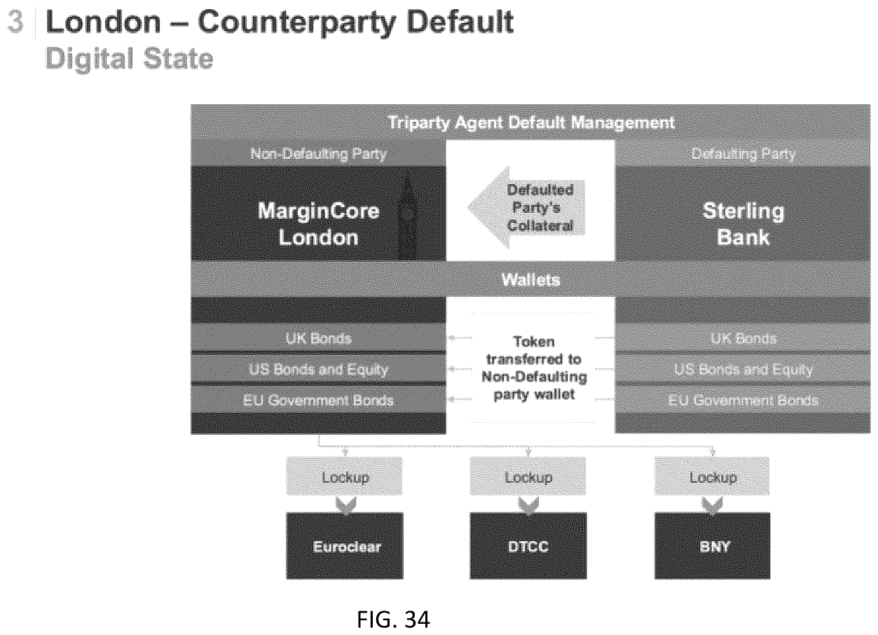

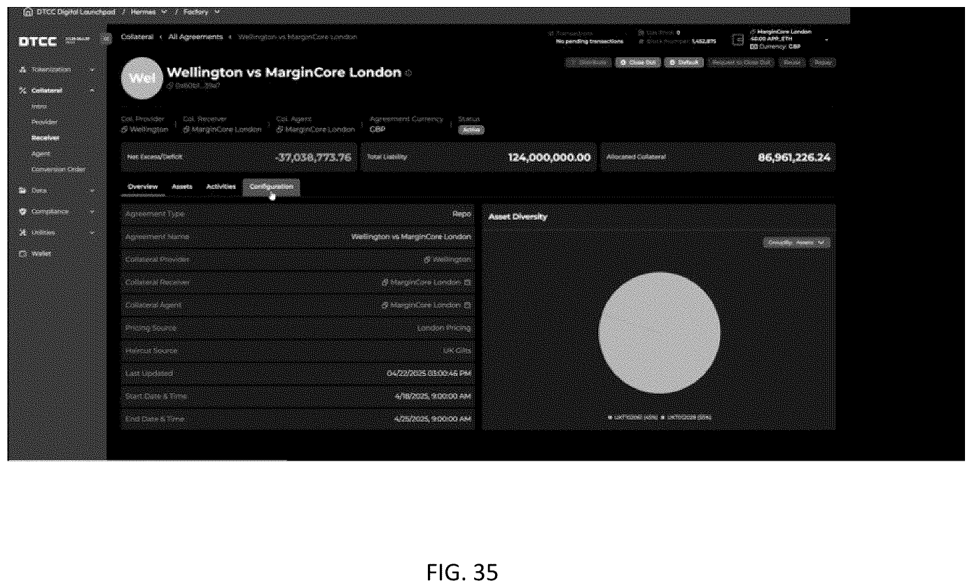

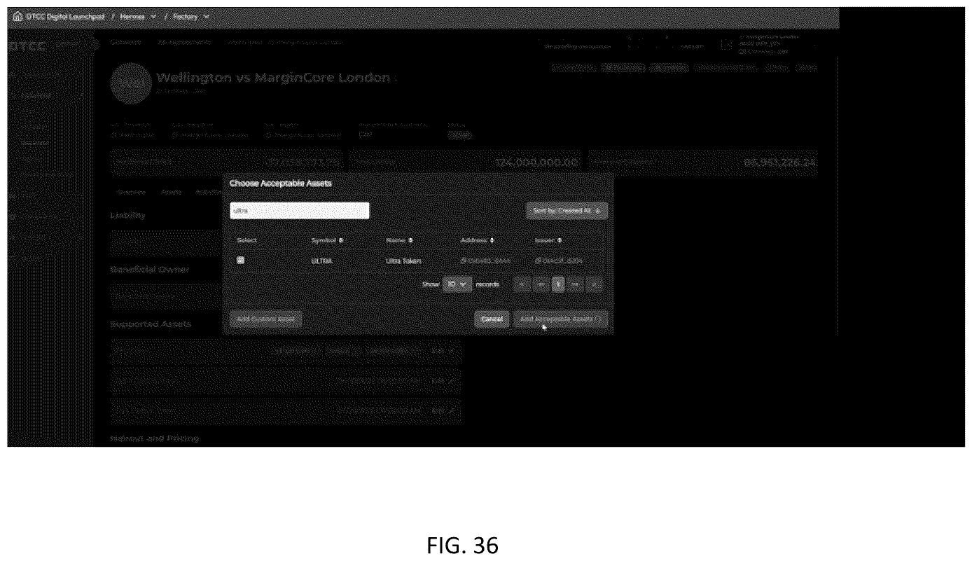

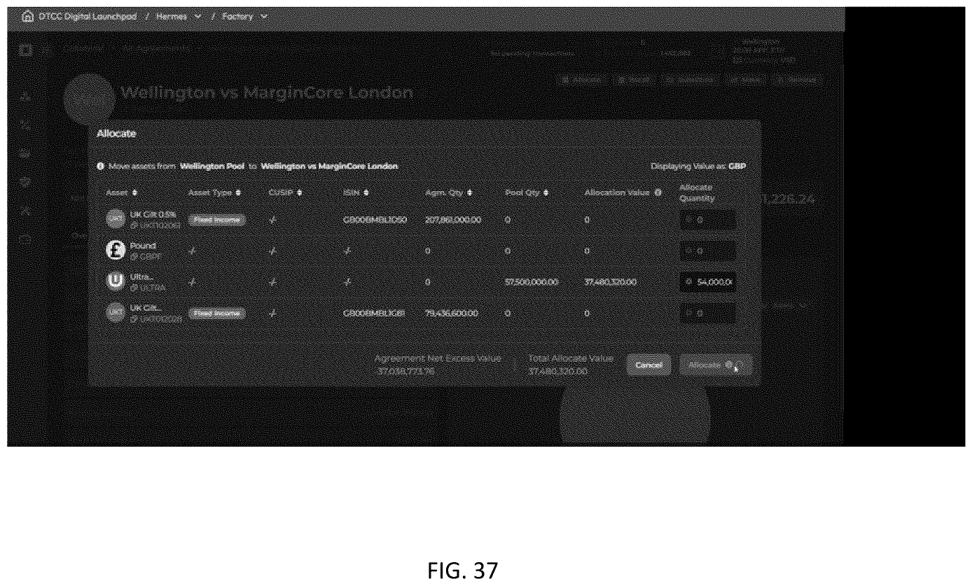

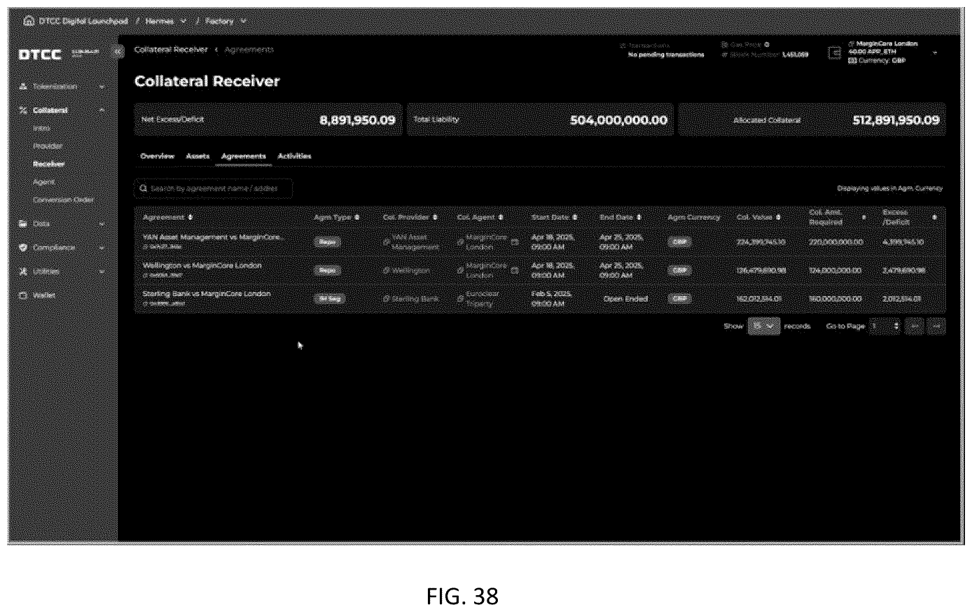

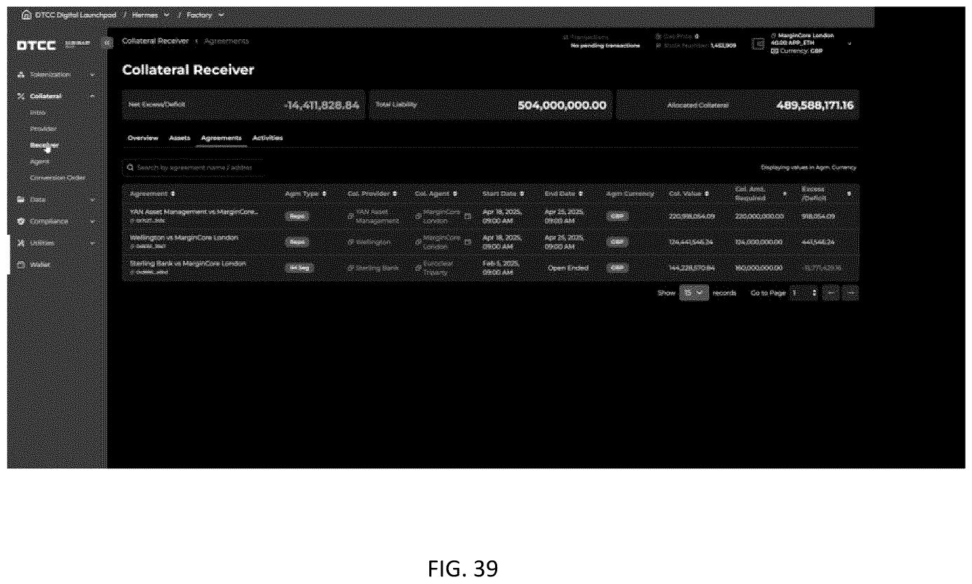

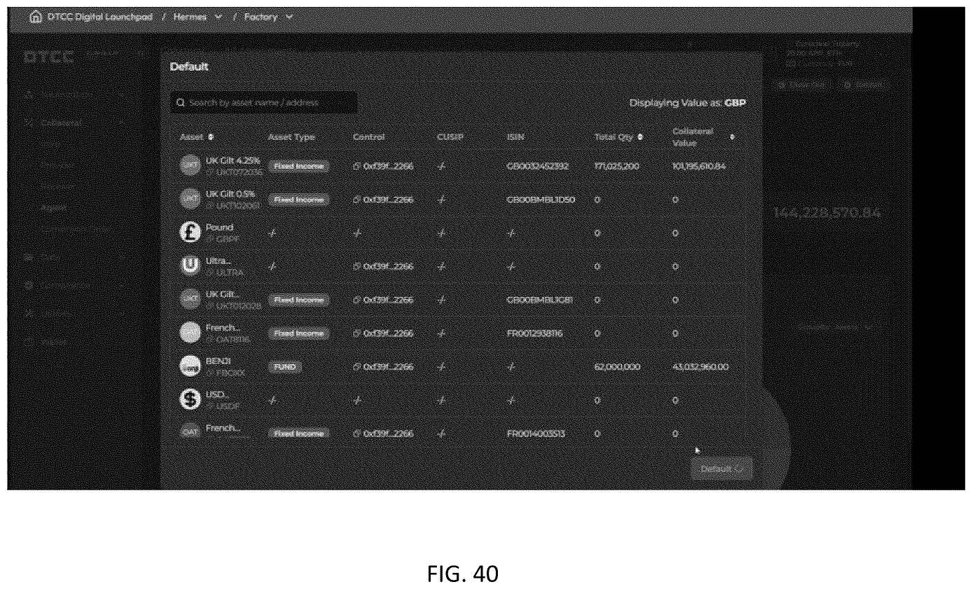

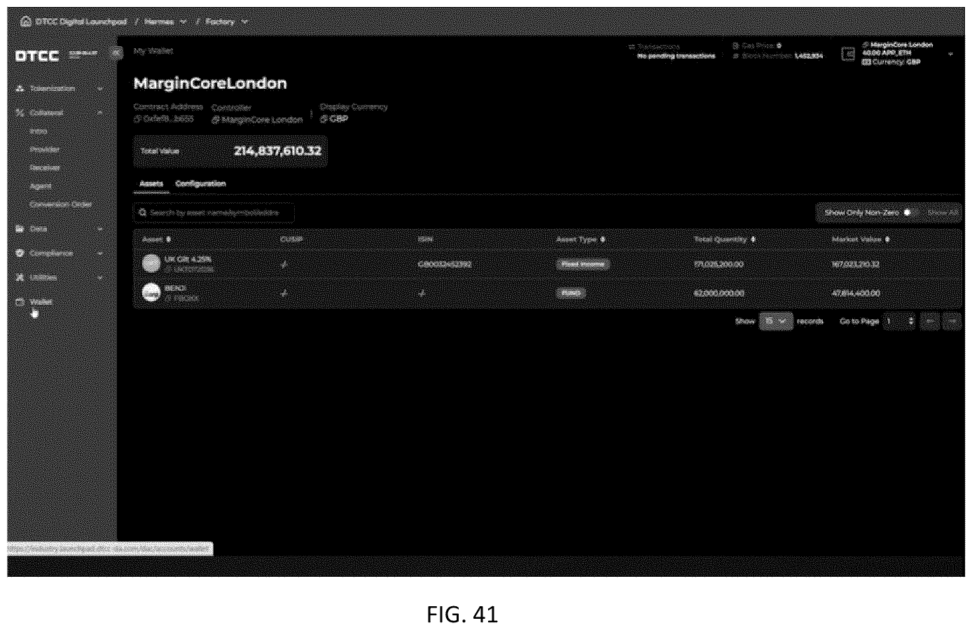

In one embodiment, the platform is operable to transfer collateral from a defaulting party to the lender. FIGS. 33-34 are diagrams of the parties, assets, and transactions involved with transactions during a major credit event, including a counterparty default. The platform of the present invention provides for real-time changes or near real-time changes to eligible collateral to support continued liquidity in the market. Smart contracts and tokenized money market funds provided by the platform of the present invention provide for counter parties to navigate a stress event more efficiently. Real-time changes to the collateral schedule allow for tokenized money market funds to be delivered and received by market participants with instantaneous or near instantaneous settlement. This seamless collateral coverage mitigates risk and eliminates the need to exchange assets for cash. FIG. 35 illustrates a GUI screenshot of a configuration page by which the platform provides for a collateral receiver to add acceptable assets as collateral. FIG. 36 illustrates a GUI screenshot showing the ULTRA token being added as acceptable collateral by the collateral receiver. This functionality is useful when a provider is not able to meet a margin call, but has other assets which are potentially acceptable to a receiver of collateral. FIG. 37 illustrates a screenshot of a collateral provider interface providing the collateral provider the ability to allocate the ULTRA token holdings to the collateral receiver. FIG. 38 illustrates a collateral receiver GUI screenshot showing a net excess after the collateral provider allocated the ULTRA token holdings to the collateral receiver. FIG. 39 illustrates a collateral receiver GUI screenshot showing a net deficit after a collateral provider defaulted and has become insolvent. FIG. 40 illustrates a default GUI screenshot showing the third-party agent changing the status of the collateral provider to default. FIG. 41 illustrates a GUI screenshot showing the collateral which has been transferred from the collateral provider to the collateral receiver as assets belonging to the collateral receiver after the default.

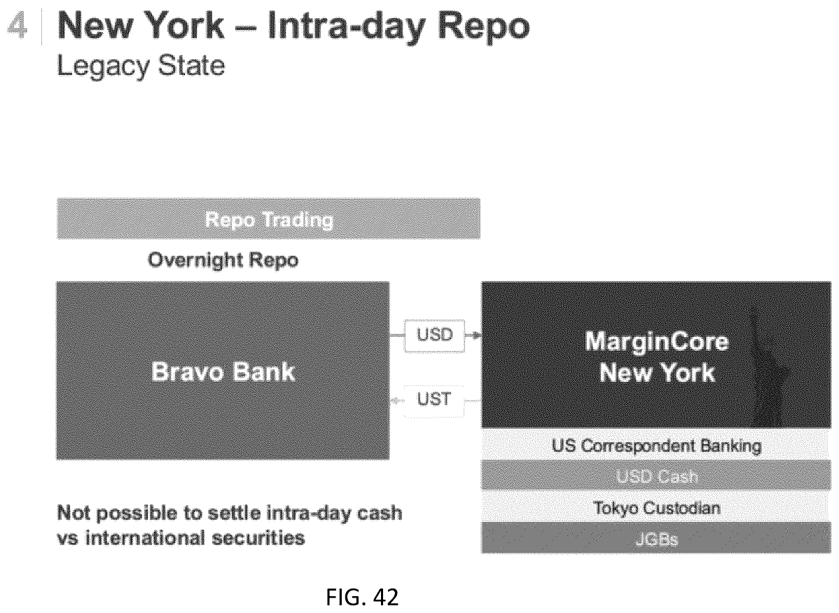

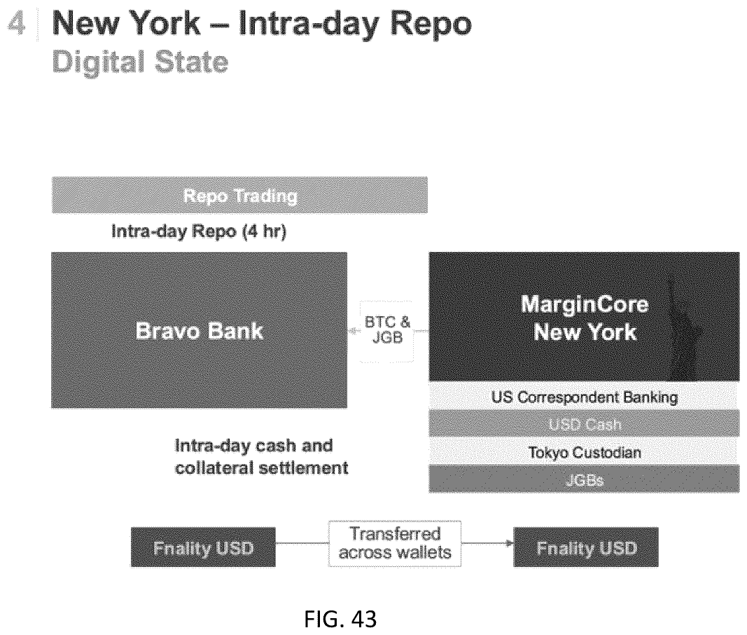

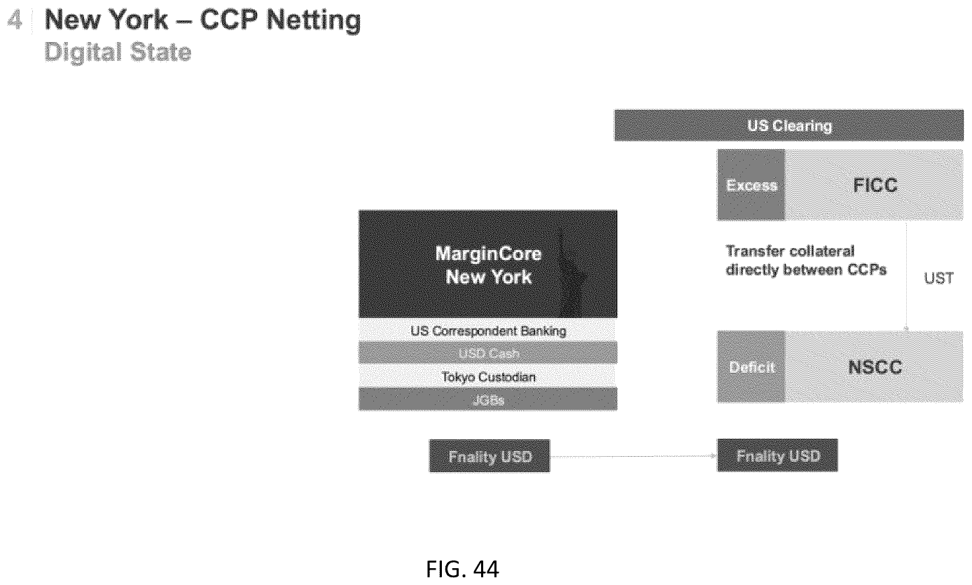

In one embodiment, the platform is operable to transfer collateral directly between CCP accounts, without requiring transfer to the financial institution in between CCP accounts. FIG. 42 illustrates prior art intra-day repo trading. FIG. 43 illustrates a schematic diagram of the parties and assets involved in an intra-day repo trade on the platform of the present invention. FIG. 44 illustrates a schematic diagram of the parties and assets involved in CCP netting (clearing) on the platform of the present invention. For example, a financial institution (MarginCore New York) receives a margin call from NSCC, in which the financial institution has excess of FICC. The financial institution can use the platform of the present invention to move the collateral directly from FICC to NSCC to satisfy the margin call.

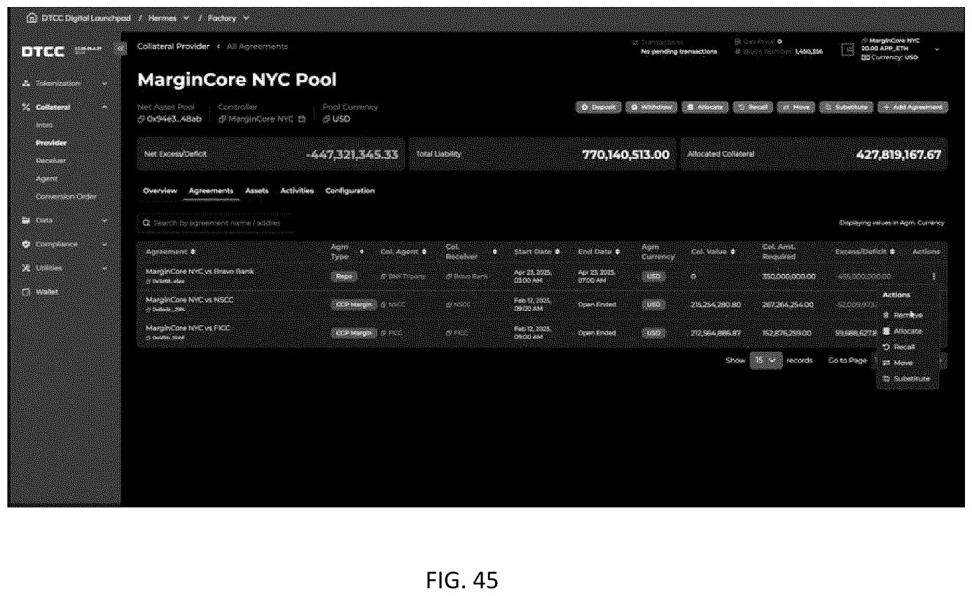

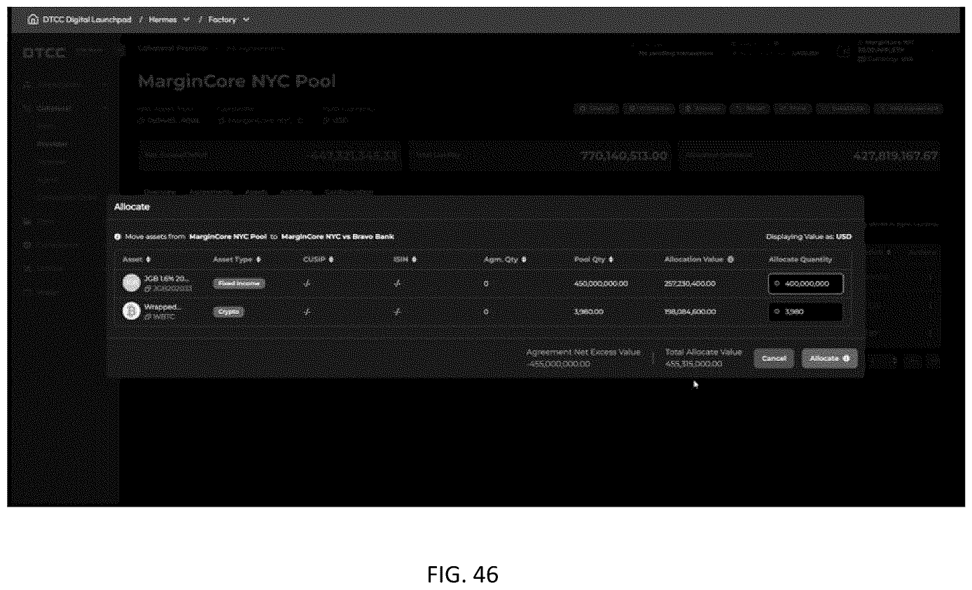

FIG. 45 illustrates a screenshot of the platform GUI including an overview of the margin agreements between a collateral provider (MarginCore NYC) and collateral receivers (Bravo Bank, NSCC, and FICC). The overview indicates the net excess/deficit, as well as the total liability, the allocated collateral, and the excess/deficit for each agreement. FIG. 46 illustrates a screenshot of the platform GUI providing for allocation of assets to meet a margin call.

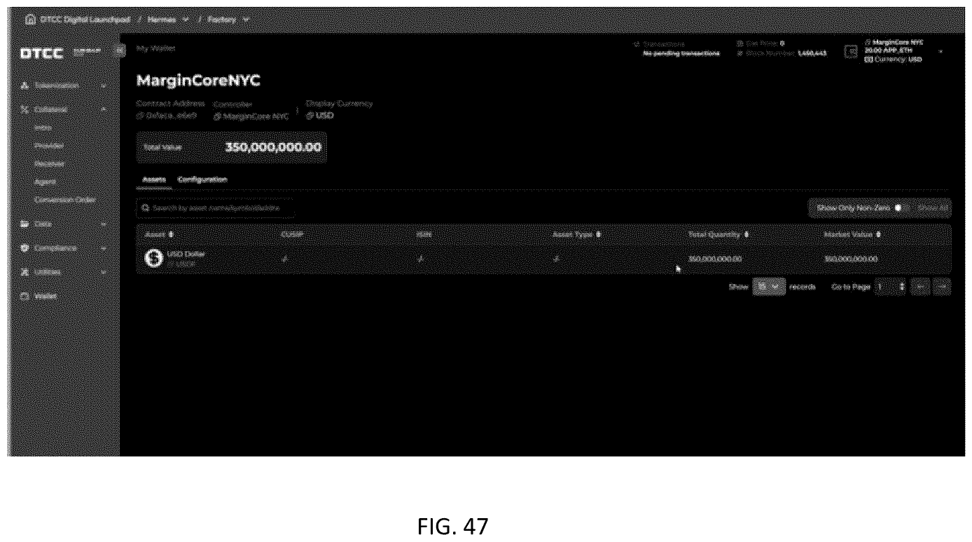

FIG. 47 illustrates a screenshot of the platform GUI providing a wallet overview. The wallet includes the asset(s) within the wallet.

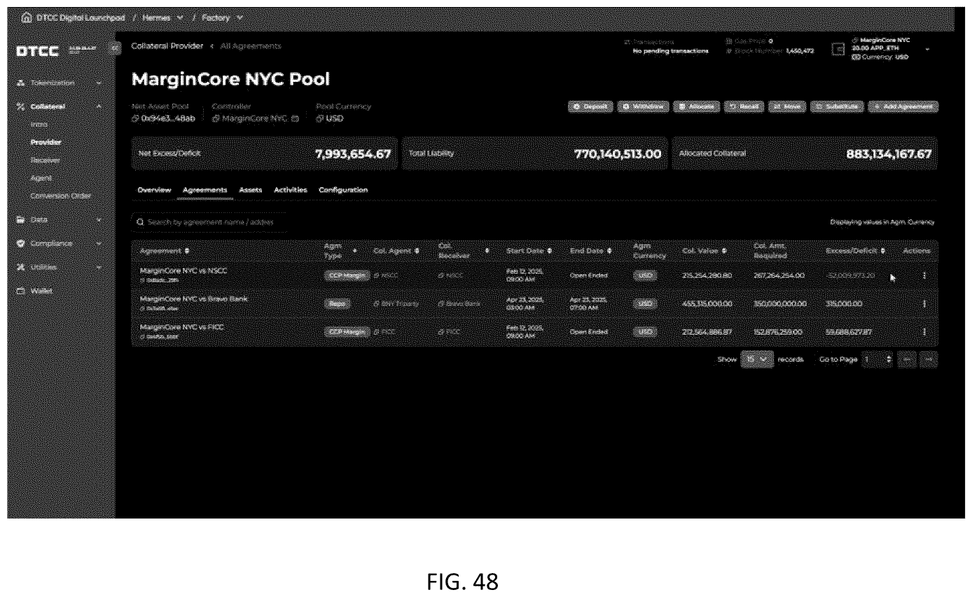

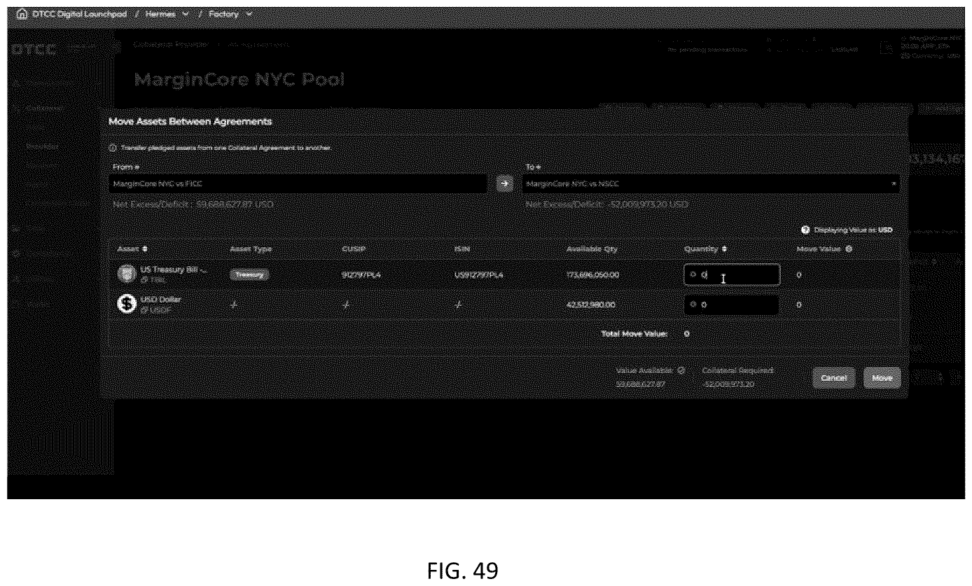

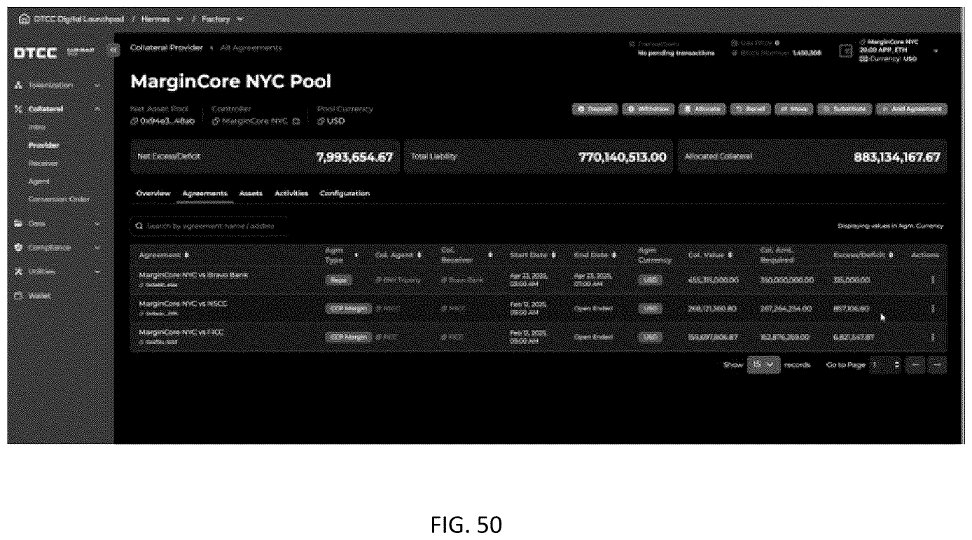

FIG. 48 illustrates a screenshot of the platform GUI including an overview of the margin agreements between a collateral provider (MarginCore NYC) and collateral receivers (NSCC, Bravo Bank, and FICC). The agreement overview indicates the excess/deficit for each collateral receiver. FIG. 49 illustrates a screenshot of the platform GUI providing for moving assets between agreements. FIG. 50 illustrates a screenshot of the platform GUI including an overview of the margin agreements between a collateral provider (MarginCore NYC) and collateral receivers (Bravo Bank, NSCC<and FICC). The agreement overview indicates the net excess/deficit, as well as the total liability and the allocated collateral. This direct transfer of collateral between CCPs enhances collateral mobility by transferring directly from one CCP to another, without having the financial organization as an intermediary. Thus, a financial organization can cover any exposure or deficit without having to use additional cash, as tokenized assets can be used to cover the deficits.

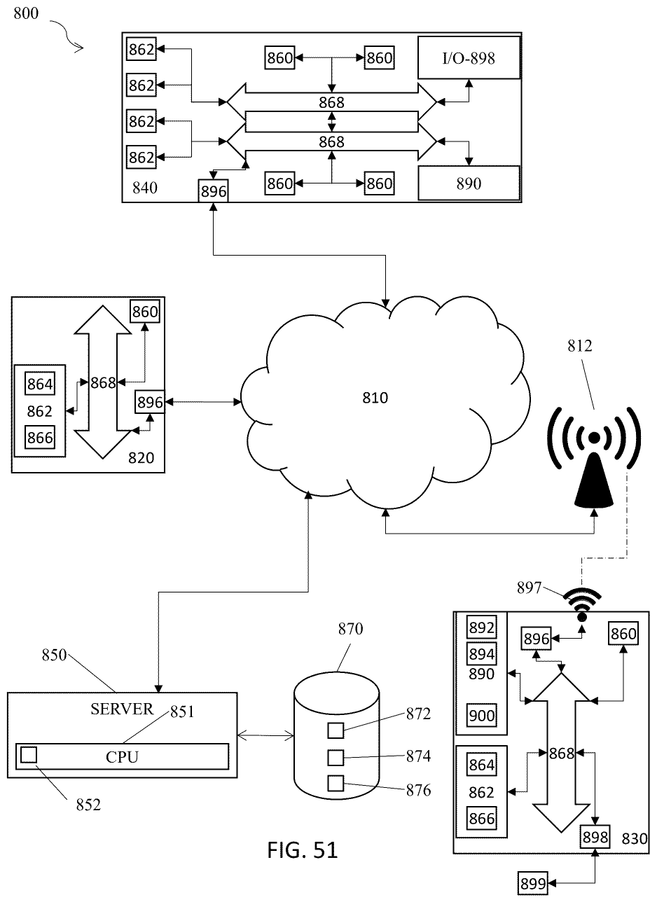

FIG. 51 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 51, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable to be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 51, is operable to include other components that are not explicitly shown in FIG. 51, or is operable to utilize an architecture completely different than that shown in FIG. 51. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

1. A system for collateral mobility and management over at least one distributed ledger network, comprising:
at least one computer processor;
at least one memory storing computer readable instructions thereon;
a layered blockchain;
a net asset pool, wherein the net asset pool is a smart contract account abstraction;
a tokenization module operable to tokenize at least one collateral asset; and
a collateral module, comprising a provider function, a receiver function, an agent function, and a conversion order function;
wherein the provider function is operable to facilitate a deposit of the at least one collateral asset into a collateral pool, withdraw the at least one collateral asset from the collateral pool, allocate the at least one collateral asset, and/or substitute the at least one collateral asset;
wherein the receiver function is operable to receive the at least one collateral asset;
wherein the agent function is operable to manage the at least one collateral asset;
wherein the conversion order function is operable to execute a conversion order between a traditional asset and a digital asset; and
wherein the collateral module includes at least one collateral agreement automatically generated from at least one rule;
wherein the at least one distributed ledger network is operable to connect to at least one second distributed ledger network, wherein a graph structure is operable to connect the at least one distributed ledger network to the at least one second distributed ledger network; and
wherein the at least one tokenized collateral asset is operable to be transferred from a first party to a second party in real time across the distributed ledger networks.

2. The system of claim 1, wherein the graph structure includes transaction nodes within transfer networks and bridges that connect networks.

3. The system of claim 1, wherein the transfer of the at least one tokenized collateral asset is based on the at least one collateral agreement.

4. The system of claim 1, wherein the system is operable to tokenize any collateral asset, regardless of issuer or protocol.

5. The system of claim 1, wherein the system is operable to control the movement of the tokenized collateral asset through self-executing smart contracts.

6. The system of claim 1, wherein the system is operable to execute the collateral agreement at any time of day.

7. The system of claim 1, wherein the system is operable to interact with any wallet or custody solution.

8. The system of claim 1, wherein the system is operable settle the transfer of the at least one tokenized collateral asset in real-time.

9. A system for collateral mobility and management over at least one distributed ledger network, comprising:
at least one computer processor;
at least one memory storing computer readable instructions thereon;
a net asset pool, wherein the net asset pool is a smart contract account abstraction;
a tokenization module operable to tokenize at least one collateral asset; and
a collateral module, comprising a provider function, a receiver function, an agent function, and a conversion order function;
wherein the conversion order function is operable to execute a conversion order between a traditional asset and a digital asset;
wherein the collateral module includes at least one collateral agreement automatically generated from at least one rule;
wherein the net asset pool is operable to execute a withdrawal of the at least one tokenized collateral asset based on the collateral agreement;
wherein the at least one distributed ledger network is operable to connect to at least one second distributed ledger network, wherein a graph structure is operable to connect the at least one distributed ledger network to the at least one second distributed ledger network; and
wherein the tokenized collateral asset is operable to be transferred from a first party to a second party in real time across the distributed ledger networks.

10. The system of claim 9, wherein the system is operable to interact with any wallet or custody solution.

11. The system of claim 9, wherein the system is operable to tokenize any collateral asset, regardless of issuer or protocol.

12. The system of claim 9, wherein the graph structure includes transaction nodes within transfer networks and bridges that connect networks.

13. The system of claim 9, wherein the transfer of the at least one tokenized collateral asset is based on the at least one collateral agreement.

14. The system of claim 9, wherein the collateral agreement is operable to be executed at any time of day.

15. A system for collateral mobility and management over at least one distributed ledger network, comprising:
at least one computer processor;
at least one memory storing computer readable instructions thereon;
a layered blockchain;
a net asset pool;
a tokenization module operable to tokenize at least one collateral asset; and
a collateral module, comprising a provider function, a receiver function, an agent function, and a conversion order function;
wherein the conversion order function is operable to execute a conversion order between a traditional asset and a digital asset; and
wherein the collateral module includes at least one collateral agreement automatically generated from at least one rule;
wherein the at least one distributed ledger network is operable to connect to at least one different network, wherein a graph structure is operable to connect the at least one distributed ledger network to the at least one different network;
wherein the graph structure includes a first data structure representing a first transaction node having an address within the at least one distributed ledger network and a second data structure representing a second transaction node having an address within the at least one different network, wherein the graph structure includes at least one bridge data structure operable to contain metadata indicating a pair of bridge nodes, wherein one node of the pair of bridge nodes has an address within the at least one different network;
wherein the at least one computer processor is operable to traverse the first transaction node and the second transaction node and generate transaction routing information from the first transaction node to the second transaction node based on the graph structure by identifying at least one network path using a plurality of network nodes and the pair of bridge nodes; and
wherein the at least one tokenized collateral asset is operable to be transferred from a first party to a second party in real time across the at least one distributed ledger network and the at least one different network using the transaction routing information.

16. The system of claim 15, wherein the system is operable to settle the transfer of the at least one tokenized collateral asset in real-time.

17. The system of claim 15, wherein the transfer of the at least one tokenized collateral asset is based on the at least one collateral agreement.

18. The system of claim 15, wherein the system is operable to tokenize any collateral asset, regardless of issuer or protocol.

19. The system of claim 15, wherein the system is operable to control the movement of the tokenized collateral asset through self-executing smart contracts.

20. The system of claim 15, wherein the system is operable to interact with any wallet or custody solution.
